(19) United States
(12) Patent Application Publication
(10) Pub. No.: US 2017/0083318 A1
(43) Pub. Date: Mar. 23, 2017

(54) Configuring modes of processor operation

(71) Applicant: Microsoft Technology Licensing, LLC, Redmond, WA (US)

(72) Inventors: Douglas C. Burger, Bellevue, WA (US); Aaron L. Smith, Seattle, WA (US)

(73) Assignee: Microsoft Technology Licensing, LLC, Redmond, WA (US)

(21) Appl. No.: 14/757,944

(22) Filed: Dec. 23, 2015

Related U.S. Application Data
(60) Provisional application No. 62/221,003, filed on Sep. 19, 2015.

(51) Int. Cl. G06F 9/30

(52) U.S. Cl. CPC G06F 9/3016; G06F 9/3004

(57) ABSTRACT

Apparatus and methods are disclosed for configuring, operating, and compiling code for, block-based processor architectures. In one example of the disclosed technology, a block-based processor includes processor cores configured to decode an instruction block header for a block-based processor instruction block including one or more fields and configure at least one of the cores to execute instructions in the instruction block according to a mode of operation specified by at least one of the fields, the modes including one or more of the following: core fusion operation, vector mode operation, memory dependence prediction operation, and/or deterministic order of execution.

### CROSS-REFERENCE TO RELATED APPLICATIONS

This application claims the benefit of U.S. Provisional Patent Application No. 62/221,003, entitled “BLOCK-BASED PROCESSORS,” filed Sep. 19, 2015, which application is incorporated herein by reference in its entirety.

### BACKGROUND

Microprocessors have benefited from continuing gains in transistor count, integrated circuit cost, manufacturing capital, clock frequency, and energy efficiency due to continued transistor scaling predicted by Moore's law, with little change in associated processor Instruction Set Architectures (ISAs). However, the benefits realized from photolithographic scaling, which drove the semiconductor industry over the last 40 years, are slowing or even reversing. Reduced Instruction Set Computing (RISC) architectures have been the dominant paradigm in processor design for many years. Out-of-order superscalar implementations have not exhibited sustained improvement in area or performance. Accordingly, there is ample opportunity for improvements in processor ISAs to extend performance improvements.

### SUMMARY

Methods, apparatus, and computer-readable storage devices are disclosed for configuring, operating, and compiling code for, block-based processor architectures (BB-ISAs) including explicit data graph execution (EDGE) architectures. The described techniques and tools for solutions for, e.g., improving processor performance and/or reducing energy consumption can be implemented separately, or in various combinations with each other. As will be described more fully below, the described techniques and tools can be implemented in a digital signal processor, microprocessor, application-specific integrated circuit (ASIC), a soft processor (e.g., a microprocessor core implemented in a field programmable gate array (FPGA) using reconfigurable logic), programmable logic, or other suitable logic circuitry. As will be readily apparent to one of ordinary skill in the art, the disclosed technology can be implemented in various computing platforms, including, but not limited to, servers, mainframes, cellphones, smartphones, PDAs, handheld devices, handheld computers, PDAs, touch screen tablet devices, tablet computers, wearable computers, and laptop computers.

In one example of the disclosed technology, a block-based processor includes processor cores configured to decode an instruction block header for a block-based processor instruction block including data and configure at least one of the cores to execute instructions in the instruction block according to a mode of operation specified by the data, the modes including one or more of the following: core fusion operation, vector mode operation, memory dependence prediction operation, or deterministic order of execution. In some examples, a method includes operating a processor according to a mode of operation specified by the data, including core fusion operation, vector mode operation, memory dependence prediction operation, or deterministic order of execution. In some examples, a method includes transforming source and/or object code into computer-executable instructions for operating a block-based processor for performed the disclosed methods. In some examples, instructions for operating the processor according to one or more specified modes of operation are stored in a computer-readable storage medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. The foregoing and other objects, features, and advantages of the disclosed subject matter will become more apparent from the following detailed description, which proceeds with reference to the accompanying figures.

### BRIEF DESCRIPTION OF THE DRAWINGS

FIG. 1 illustrates a block-based processor core, as can be used in some examples of the disclosed technology.

FIG. 2 illustrates a block-based processor core, as can be used in some examples of the disclosed technology.

FIG. 3 illustrates a number of instruction blocks, according to certain examples of disclosed technology.

FIG. 4 illustrates portions of source code and instruction blocks, as can be used in some examples of the disclosed technology.

FIG. 5 illustrates block-based processor headers and instructions, as can be used in some examples of the disclosed technology.

FIG. 6 illustrates examples of source and assembler code, as can be used in some examples of the disclosed technology.

FIG. 7 illustrates a number of instructions blocks and processor cores, as can be used in some examples of the disclosed technology.

FIG. 8 is a flowchart illustrating an example method of executing instructions for an instruction block according to a selected operation mode, as can be performed in certain examples of the disclosed technology.

FIG. 9 is a flowchart outlining an example method of configuring a processor to execute according to one or more operation modes as specified in an instruction block header, as can be performed in certain examples of the disclosed technology.

FIG. 10 is a diagram illustrating core fusion operation of a block-based processor as can be performed in certain examples of the disclosed technology.

FIG. 11 is a diagram illustrating master-follower vector operation, as can be performed in certain examples of the disclosed technology.

FIG. 12 is a diagram illustrating an example of distributed vector mode operation, as can be performed in certain examples of the disclosed technology.

FIGS. 13A and 13B are examples of code that can be executed in order, or out of order, in certain examples of the disclosed technology.

FIG. 14 is an example of source code including aliasing that can be executed in certain examples of the disclosed technology.

FIG. 15 is an example of source code including I/O operations, as can be executed in certain examples of the disclosed technology.

FIG. 16 is a flowchart outlining an example of transforming code into block-based processor executable code including execution mode flags, as can be performed in certain examples of the disclosed technology.

FIG. 17 is a block diagram illustrating a suitable computing environment for implementing some embodiments of the disclosed technology.

### DETAILED DESCRIPTION

### I. General Considerations

This disclosure is set forth in the context of representative embodiments that are not intended to be limiting in any way.

As used in this application the singular forms “a,” “an,” and “the” include the plural forms unless the context clearly dictates otherwise. Additionally, the term “includes” means “comprises.” Further, the term “coupled” encompasses mechanical, electrical, magnetic, optical, as well as other practical ways of coupling or linking items together, and does not exclude the presence of intermediate elements between the coupled items. Furthermore, as used herein, the term “and/or” means any one item or combination of items in the phrase.

The systems, methods, and apparatus described herein should not be construed as being limiting in any way. Instead, this disclosure is directed toward all novel and non-obvious features and aspects of the various disclosed embodiments, alone and in various combinations and subcombinations with one another. The disclosed systems, methods, and apparatus are not limited to any specific aspect or feature or combinations thereof, nor do the disclosed things and methods require that any one or more specific advantages be present or problems be solved. Furthermore, any features or aspects of the disclosed embodiments can be used in various combinations and subcombinations with one another.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed things and methods can be used in conjunction with other things and methods. Additionally, the description sometimes uses terms like “produce,” “generate,” “display,” “receive,” “emit,” “verify,” “execute,” and “initiate” to describe the disclosed methods. These terms are high-level descriptions of the actual operations that are performed. The actual operations that correspond to these terms will vary depending on the particular implementation and are readily discernible by one of ordinary skill in the art.

Theories of operation, scientific principles, or other theoretical descriptions presented herein in reference to the apparatus or methods of this disclosure have been provided for the purposes of better understanding and are not intended to be limiting in scope. The apparatus and methods in the appended claims are not limited to those apparatus and methods that function in the manner described by such theories of operation.

Any of the disclosed methods can be implemented as computer-executable instructions stored on one or more computer-readable media (e.g., computer-readable media, such as one or more optical media discs, volatile memory components (such as DRAM or SRAM), or nonvolatile memory components (such as hard drives)) and executed on a computer (e.g., any commercially available computer, including smart phones or other mobile devices that include computing hardware). Any of the computer-executable instructions for implementing the disclosed techniques, as well as any data created and used during implementation of the disclosed embodiments, can be stored on one or more computer-readable media (e.g., computer-readable storage media). The computer-executable instructions can be part of, for example, a dedicated software application or a software application that is accessed or downloaded via a web browser or other software application (such as a remote computing application). Such software can be executed, for example, on a single local computer (e.g., with general-purpose and/or block based processors executing on any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C, C++, Java, or any other suitable programming language. Likewise, the disclosed technology is not limited to any particular computer or type of hardware. Certain details of suitable computers and hardware are well-known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

### II. Introduction to the Disclosed Technologies

Superscalar out-of-order microarchitectures employ substantial circuit resources to rename registers, schedule instructions in dataflow order, clean up after miss-speculation, and retire results in-order for precise exceptions. This includes expensive circuits, such as deep, many-ported register files, many-ported content-accessible memories (CAMs) for dataflow instruction scheduling wakeup, and many-wide bus multiplexers and bypass networks, all of which are resource intensive. For example, FPGA-based implementations of multi-read, multi-write RAMs typically require a mix of replication, multi-cycle operation, clock doubling, bank interleaving, live-value tables, and other expensive techniques.

The disclosed technologies can realize performance enhancement through application of techniques including high instruction-level parallelism (ILP), out-of-order (OoO), superscalar execution, while avoiding substantial complexity and overhead in both processor hardware and associated software. In some examples of the disclosed technology, a block-based processor uses an EDGE ISA designed for area- and energy-efficient, high-ILP execution. In some examples, use of EDGE architectures and associated compilers finesses away much of the register renaming, CAMs, and complexity.

In certain examples of the disclosed technology, an EDGE ISA can eliminate the need for one or more complex architectural features, including register renaming, dataflow analysis, misspeculation recovery, and in-order retirement while supporting mainstream programming languages such as C and C++. In certain examples of the disclosed technology, a block-based processor executes a plurality of two or more instructions as an atomic block. Block-based instructions can be used to express semantics of program data flow and/or instruction flow in a more explicit fashion, allowing for improved compiler and processor performance. In certain examples of the disclosed technology, an explicit data graph execution instruction set architecture (EDGE ISA) includes information about program control flow that can be used to improve detection of improper control flow instructions, thereby increasing performance, saving memory resources, and/or and saving energy.

In some examples of the disclosed technology, instructions organized within instruction blocks are fetched, executed, and committed atomically. Instructions inside blocks execute in dataflow order, which reduces or eliminates using register renaming and provides power-efficient OoO execution. A compiler can be used to explicitly encode data dependencies through the ISA, reducing or eliminating burdening processor core control logic from rediscovering dependencies at runtime. Using predicated execution, intra-block branches can be converted to dataflow instructions, and dependencies, other than memory dependencies, can be limited to direct data dependencies. Disclosed target form encoding techniques allow instructions within a block to communicate their operands directly via operand buffers, reducing accesses to a power-hungry, multi-ported physical register files.

Between instruction blocks, instructions can communicate using memory and registers. Thus, by utilizing a hybrid dataflow execution model, EDGE architectures can still support imperative programming languages and sequential memory semantics, but desirably also enjoy the benefits of out-of-order execution with near in-order power efficiency and complexity.

As will be readily understood to one of ordinary skill in the relevant art, a spectrum of implementations of the disclosed technology are possible with various area and performance tradeoffs.

### III. Example Block-Based Processor

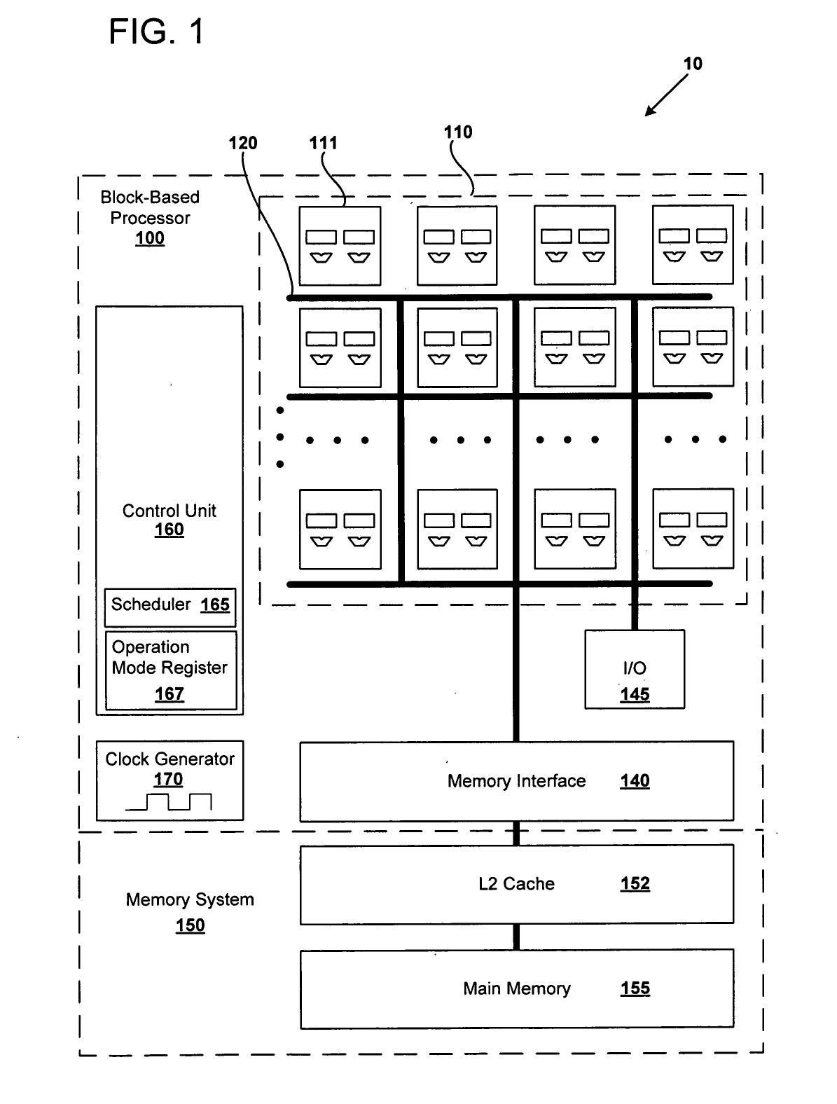

FIG. 1 is a block diagram 10 of a block-based processor 100 as can be implemented in some examples of the disclosed technology. The processor 100 is configured to execute atomic blocks of instructions according to an instruction set architecture (ISA), which describes a number of aspects of processor operation, including a register model, a number of defined operations performed by block-based instructions, a memory model, interrupts, and other architectural features. The block-based processor includes a plurality of processing cores 110, including a processor core 111.

As shown in FIG. 1, the processor cores are connected to each other via core interconnect 120. The core interconnect 120 carries data and control signals between individual ones of the cores 110, a memory interface 140, and an input/output (I/O) interface 145. The core interconnect 120 can transmit and receive signals using electrical, optical, magnetic, or other suitable communication technology and can provide communication connections arranged according to a number of different topologies, depending on a particular desired configuration. For example, the core interconnect 120 can have a crossbar, a bus, a point-to-point bus, or other suitable topology. In some examples, any one of the cores 110 can be connected to any of the other cores, while in other examples, some cores are only connected to a subset of the other cores. For example, each core may only be connected to a nearest 4, 8, or 20 neighboring cores. The core interconnect 120 can be used to transmit input/output data to and from the cores, as well as transmit control signals and other information signals to and from the cores. For example, each of the cores 110 can receive and transmit semaphores that indicate the execution status of instructions currently being executed by each of the respective cores. In some examples, the core interconnect 120 is implemented as wires connecting the cores 110, and memory system, while in other examples, the core interconnect can include circuitry for multiplexing data signals on the interconnect wire(s), switch and/or routing components, including active signal drivers and repeaters, or other suitable circuitry. In some examples of the disclosed technology, signals transmitted within and to/from the processor 100 are not limited to full swing electrical digital signals, but the processor can be configured to include differential signals, pulsed signals, or other suitable signals for transmitting data and control signals.

In the example of FIG. 1, the memory interface 140 of the processor includes interface logic that is used to connect to additional memory, for example, memory located on another integrated circuit besides the processor 100. As shown in FIG. 1 an external memory system 150 includes an L2 cache 152 and main memory 155. In some examples the L2 cache can be implemented using static RAM (SRAM) and the main memory 155 can be implemented using dynamic RAM (DRAM). In some examples the memory system 150 is included on the same integrated circuit as the other components of the processor 100. In some examples, the memory interface 140 includes a direct memory access (DMA) controller allowing transfer of blocks of data in memory without using register file(s) and/or the processor 100. In some examples, the memory interface manages allocation of virtual memory, expanding the available main memory 155.

The I/O interface 145 includes circuitry for receiving and sending input and output signals to other components, such as hardware interrupts, system control signals, peripheral interfaces, co-processor control and/or data signals (e.g., signals for a graphics processing unit, floating point coprocessor, physics processing unit, digital signal processor, or other co-processing components), clock signals, semaphores, or other suitable I/O signals. The I/O signals may be synchronous or asynchronous. In some examples, all or a portion of the I/O interface is implemented using memory-mapped I/O techniques in conjunction with the memory interface 140.

The block-based processor 100 can also include a control unit 160. The control unit 160 supervises operation of the processor 100. Operations that can be performed by the control unit 160 can include allocation and de-allocation of cores for performing instruction processing, control of input data and output data between any of the cores, register files, the memory interface 140, and/or the I/O interface 145, modification of execution flow, and verifying target location(s) of branch instructions, instruction headers, and other changes in control flow. The control unit 160 can allocate and de-allocate cores for core fusion operation or vector mode operation, for example.

The control unit 160 can also be used to configure the processor to execute instructions in the instruction block according to a mode of operation specified by data stored in, for example, an instruction block header, a register configured by executing a processor instruction, or in a designated architectural register or memory location. Suitable modes of operation for which the processor can be operated according to include core fusion operation, vector mode operation, memory dependence prediction operation, or deterministic order of execution.

The control unit 160 can also process hardware interrupts, and control reading and writing of special system registers, for example the program counter stored in one or more register file(s). In some examples of the disclosed technology, the control unit 160 is at least partially implemented using one or more of the processing cores 110, while in other examples, the control unit 160 is implemented using a non-block-based processing core (e.g., a general-purpose RISC processing core coupled to memory). In some examples, the control unit 160 is implemented at least in part using one or more of: hardwired finite state machines, programmable microcode, programmable gate arrays, or other suitable control circuits. In alternative examples, control unit functionality can be performed by one or more of the cores 110.

In some examples, the instruction scheduler 206 is implemented using a general-purpose processor coupled to memory, the memory being configured to store data for scheduling instruction blocks. In some examples, instruction scheduler 206 is implemented using a special purpose processor or using a block-based processor core coupled to the memory. In some examples, the instruction scheduler 206 is implemented as a finite state machine coupled to the memory. In some examples, an operating system executing on a processor (e.g., a general-purpose processor or a block-based processor core) generates priorities, predictions, and other data that can be used at least in part to schedule instruction blocks with the instruction scheduler 206. As will be readily apparent to one of ordinary skill in the relevant art, other circuit structures, implemented in an integrated circuit, programmable logic, or other suitable logic can be used to implement hardware for the instruction scheduler 206.

The control unit 160 includes a scheduler 165 that is used to allocate instruction blocks to the processor cores 110. As used herein, scheduler allocation refers to directing operation of an instruction blocks, including initiating instruction block mapping, fetching, decoding, execution, committing, aborting, idling, and refreshing an instruction block. Processor cores 110 are assigned to instruction blocks during instruction block mapping. The recited stages of instruction operation are for illustrative purposes, and in some examples of the disclosed technology, certain operations can be combined, omitted, separated into multiple operations, or additional operations added. The scheduler 165 schedules the flow of instructions including allocation and de-allocation of cores for performing instruction processing, control of input data and output data between any of the cores, register files, the memory interface 140, and/or the I/O interface 145. The control unit 60 also includes an operation mode register 167, which can be used to store data indicating one or more mode of operations for an instruction block.

The block-based processor 100 also includes a clock generator 170, which distributes one or more clock signals to various components within the processor (e.g., the cores 110, interconnect 120, memory interface 140, and I/O interface 145). In some examples of the disclosed technology, all of the components share a common clock, while in other examples different components use a different clock, for example, a clock signal having differing clock frequencies. In some examples, a portion of the clock is gated to allowing power savings when some of the processor components are not in use. In some examples, the clock signals are generated using a phase-locked loop (PLL) to generate a signal of fixed, constant frequency and duty cycle. Circuitry that receives the clock signals can be triggered on a single edge (e.g., a rising edge) while in other examples, at least some of the receiving circuitry is triggered by rising and falling clock edges. In some examples, the clock signal can be transmitted optically or wirelessly.

### IV. Example Block-Based Processor Core

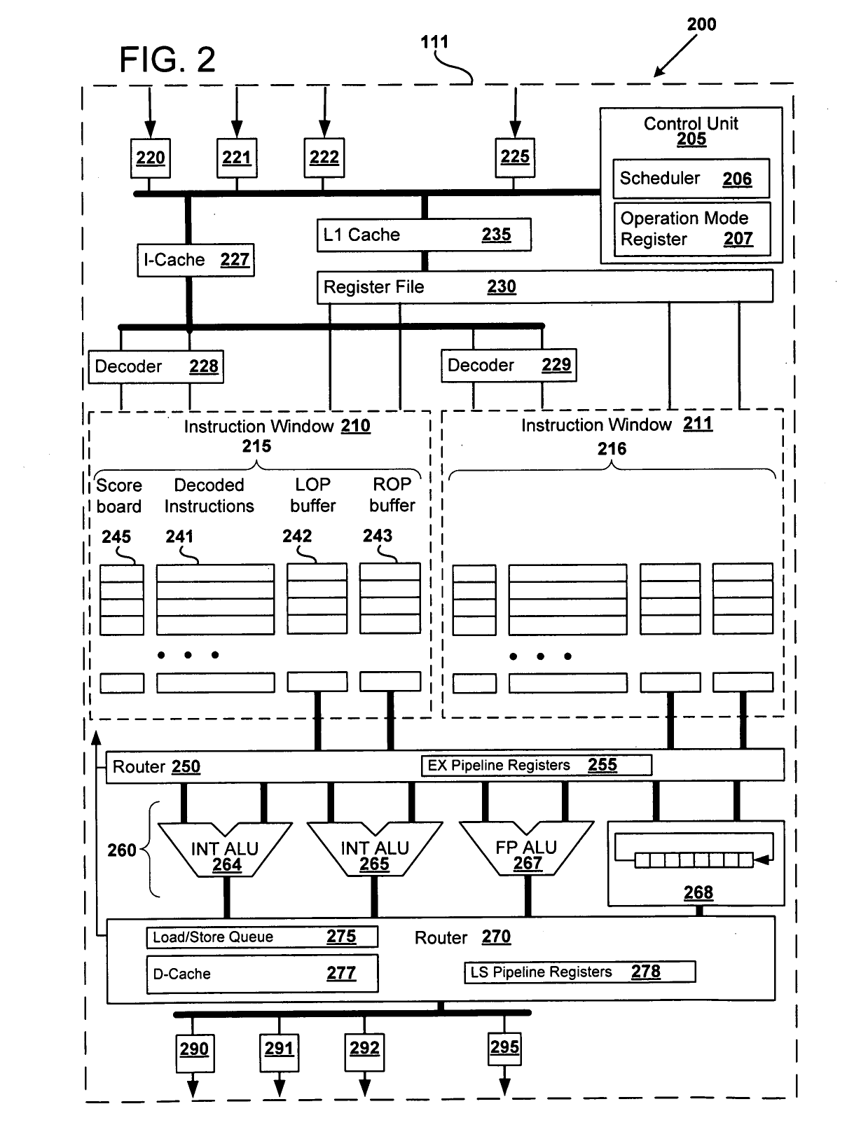

FIG. 2 is a block diagram 200 further detailing an example microarchitecture for the block-based processor 100, and in particular, an instance of one of the block-based processor cores, as can be used in certain examples of the disclosed technology. For ease of explanation, the exemplary block-based processor core is illustrated with five stages: instruction fetch (IF), decode (DC), operand fetch, execute (EX), and memory/data access (LS). However, it will be readily understood by one of ordinary skill in the relevant art that modifications to the illustrated microarchitecture, such as adding/removing stages, adding/removing units that perform operations, and other implementation details can be modified to suit a particular application for a block-based processor.

As shown in FIG. 2, the processor core 111 includes a control unit 205, which generates control signals to regulate core operation and schedules the flow of instructions within the core using an instruction scheduler 206. Operations that can be performed by the control unit 205 and/or instruction scheduler 206 can include allocation and de-allocation of cores for performing instruction processing, control of input data and output data between any of the cores, register files, the memory interface 140, and/or the I/O interface 145. The control unit 205 can allocate and de-allocate cores for core fusion operation or vector mode operation, for example.

The control unit 205 further includes an operation mode register that can store data specifying one or more modes of operation. For example, the control unit 205 can be used to configure the processor to execute instructions in the instruction block according to a mode of operation specified by data stored in, for example, an instruction block header, an operation mode register configured by executing a processor instruction, or in a designated architectural register or memory location. For example, the operation mode data can be stored in an operation mode register 207 that is accessible by the control unit 205 but that is not architecturally visible. Operation mode data can also be stored in a designated register in the register file 230. Suitable modes of operation for which the processor can be operated according to include core fusion operation, vector mode operation, memory dependence prediction operation, or deterministic order of execution.

The control unit 205 can also process hardware interrupts, and control reading and writing of special system registers, for example the program counter stored in one or more register file(s). In other examples of the disclosed technology, the control unit 205 and/or instruction scheduler 206 are implemented using a non-block-based processing core (e.g., a general-purpose RISC processing core coupled to memory). In some examples, the control unit 205 and/or instruction scheduler 206 are implemented at least in part using one or more of: hardwired finite state machines, programmable microcode, programmable gate arrays, or other suitable control circuits.

The exemplary processor core 111 includes two instructions windows 210 and 211, each of which can be configured to execute an instruction block. In some examples of the disclosed technology, an instruction block is an atomic collection of block-based-processor instructions that includes an instruction block header and a plurality of one or more instructions. As will be discussed further below, the instruction block header includes information that can be used to further define semantics of one or more of the plurality of instructions within the instruction block. Depending on the particular ISA and processor hardware used, the instruction block header can also be used during execution of the instructions, and to improve performance of executing an instruction block by, for example, allowing for early fetching of instructions and/or data, improved branch prediction, speculative execution, improved energy efficiency, and improved code compactness. In other examples, different numbers of instructions windows are possible, such as one, four, eight, or other number of instruction windows.

Each of the instruction windows 210 and 211 can receive instructions and data from one or more of input ports 220, 221, and 222 which connect to an interconnect bus and instruction cache 227, which in turn is connected to the instruction decoders 228 and 229. Additional control signals can also be received on an additional input port 225. Each of the instruction decoders 228 and 229 decodes instruction headers and/or instructions for an instruction block and stores the decoded instructions within a memory store 215 and 216 located in each respective instruction window 210 and 211. Further, each of the decoders 228 and 229 can send data to the control unit 205, for example, to configure operation of the processor core 111 according to a mode of operation specified in an instruction block header or in an instruction.

The processor core 111 further includes a register file 230 coupled to an L1 (level one) cache 235. The register file 230 stores data for registers defined in the block-based processor architecture, and can have one or more read ports and one or more write ports. For example, a register file may include two or more write ports for storing data in the register file, as well as having a plurality of read ports for reading data from individual registers within the register file. In some examples, a single instruction window (e.g., instruction window 210) can access only one port of the register file at a time, while in other examples, the instruction window 210 can access one read port and one write port, or can access two or more read ports and/or write ports simultaneously. In some examples, the register file 230 can include 64 registers, each of the registers holding a word of 32 bits of data. (This application will refer to 32-bits of data as a word, unless otherwise specified.) In some examples, some of the registers within the register file 230 may be allocated to special purposes. For example, some of the registers can be dedicated as system registers examples of which include registers storing constant values (e.g., an all zero word), program counter(s) (PC), which indicate the current address of a program thread that is being executed, a physical core number, a logical core number, a core assignment topology, core control flags, mode of operation flags, a processor topology, or other suitable dedicated purpose. In some examples, there are multiple program counter registers, one or each program counter, to allow for concurrent execution of multiple execution threads across one or more processor cores and/or processors. In some examples, program counters are implemented as designated memory locations instead of as registers in a register file. In some examples, use of the system registers may be restricted by the operating system or other supervisory computer instructions. In some examples, the register file 230 is implemented as an array of flip-flops, while in other examples, the register file can be implemented using latches, SRAM, or other forms of memory storage. The ISA specification for a given processor, for example processor 100, specifies how registers within the register file 230 are defined and used.

In some examples, the processor 100 includes a global register file that is shared by a plurality of the processor cores. In some examples, individual register files associate with a processor core can be combined to form a larger file, statically or dynamically, depending on the processor ISA and configuration.

As shown in FIG. 2, the memory store 215 of the instruction window 210 includes a number of decoded instructions 241, a left operand (LOP) buffer 242, a right operand (ROP) buffer 243, and an instruction scoreboard 245. In some examples of the disclosed technology, each instruction of the instruction block is decomposed into a row of decoded instructions, left and right operands, and scoreboard data, as shown in FIG. 2. The decoded instructions 241 can include partially- or fully-decoded versions of instructions stored as bit-level control signals. The operand buffers 242 and 243 store operands (e.g., register values received from the register file 230, data received from memory, immediate operands coded within an instruction, operands calculated by an earlier-issued instruction, or other operand values) until their respective decoded instructions are ready to execute. Instruction operands are read from the operand buffers 242 and 243, not the register file.

The memory store 216 of the second instruction window 211 stores similar instruction information (decoded instructions, operands, and scoreboard) as the memory store 215, but is not shown in FIG. 2 for the sake of simplicity. Instruction blocks can be executed by the second instruction window 211 concurrently or sequentially with respect to the first instruction window, subject to ISA constrained and as directed by the control unit 205.

In some examples of the disclosed technology, front-end pipeline stages IF and DC can run decoupled from the back-end pipelines stages (IS, EX, LS). The control unit can fetch and decode two instructions per clock cycle into each of the instruction windows 210 and 211. The control unit 205 provides instruction window dataflow scheduling logic to monitor the ready state of each decoded instruction's inputs (e.g., each respective instruction's predicate(s) and operand(s) using the scoreboard 245. When all of the inputs for a particular decoded instruction are ready, the instruction is ready to issue. The control unit 205 then initiates execution of one or more next instruction(s) (e.g., the lowest numbered ready instruction) each cycle and its decoded instruction and input operands are send to one or more of functional units 260 for execution. The decoded instruction can also encodes a number of ready events. The scheduler in the control unit 205 accepts these and/or events from other sources and updates the ready state of other instructions in the window. Thus execution proceeds, starting with the processor core's 111 ready zero input instructions, instructions that are targeted by the zero input instructions, and so forth.

The decoded instructions 241 need not execute in the same order in which they are arranged within the memory store 215 of the instruction window 210. Rather, the instruction scoreboard 245 is used to track dependencies of the decoded instructions and, when the dependencies have been met, the associated individual decoded instruction is scheduled for execution. For example, a reference to a respective instruction can be pushed onto a ready queue when the dependencies have been met for the respective instruction, and instructions can be scheduled in a first-in first-out (FIFO) order from the ready queue. Information stored in the scoreboard 245 can include, but is not limited to, the associated instruction's execution predicate (such as whether the instruction is waiting for a predicate bit to be calculated and whether the instruction executes if the predicate bit is true or false), availability of operands to the instruction, or other prerequisites required before executing the associated individual instruction. The number of instructions that are stored in each instruction window generally corresponds to the number of instructions within an instruction block. In some examples, the number of instructions within an instruction block can be 32, 64, 128, 1024, or another number of instructions. In some examples of the disclosed technology, an instruction block is allocated across multiple instruction windows within a processor core. Out-of-order operation and memory access can be controlled according to data specifying one or more modes of operation.

In some examples, restrictions are imposed on the processor (e.g., according to an architectural definition, or by a programmable configuration of the processor) to disable execution of instructions out of the sequential order in which the instructions are arranged in an instruction block. In some examples, the lowest-numbered instruction available is configured to be the next instruction to execute. In some examples, control logic traverses the instructions in the instruction block and executes the next instruction that is ready to execute. In some examples, only one instruction can issue and/or execute at a time. In some examples, the instructions within an instruction block issue and execute in a deterministic order (e.g., the sequential order in which the instructions are arranged in the block). In some examples, the restrictions on instruction ordering can be configured when using a software debugger to by a user debugging a program executing on a block-based processor.

Instructions can be allocated and scheduled using the control unit 205 located within the processor core 111. The control unit 205 orchestrates fetching of instructions from memory, decoding of the instructions, execution of instructions once they have been loaded into a respective instruction window, data flow into/out of the processor core 111, and control signals input and output by the processor core. For example, the control unit 205 can include the ready queue, as described above, for use in scheduling instructions. The instructions stored in the memory store 215 and 216 located in each respective instruction window 210 and 211 can be executed atomically. Thus, updates to the visible architectural state (such as the register file 230 and the memory) affected by the executed instructions can be buffered locally within the core 200 until the instructions are committed. The control unit 205 can determine when instructions are ready to be committed, sequence the commit logic, and issue a commit signal. For example, a commit phase for an instruction block can begin when all register writes are buffered, all writes to memory are buffered, and a branch target is calculated. The instruction block can be committed when updates to the visible architectural state are complete. For example, an instruction block can be committed when the register writes are written to as the register file, the stores are sent to a load/store unit or memory controller, and the commit signal is generated. The control unit 205 also controls, at least in part, allocation of functional units 260 to each of the respective instructions windows.

As shown in FIG. 2, a first router 250, which has a number of execution pipeline registers 255, is used to send data from either of the instruction windows 210 and 211 to one or more of the functional units 260, which can include but are not limited to, integer ALUs (arithmetic logic units) (e.g., integer ALUs 264 and 265), floating point units (e.g., floating point ALU 267), shift/rotate logic (e.g., barrel shifter 268), or other suitable execution units, which can including graphics functions, physics functions, and other mathematical operations. Data from the functional units 260 can then be routed through a second router 270 to outputs 290, 291, and 292, routed back to an operand buffer (e.g. LOP buffer 242 and/or ROP buffer 243), or fed back to another functional unit, depending on the requirements of the particular instruction being executed. The second router 270 include a load/store queue 275, which can be used to issue memory instructions, a data cache 277, which stores data being input to or output from the core to memory, and load/store pipeline register 278.

The core also includes control outputs 295 which are used to indicate, for example, when execution of all of the instructions for one or more of the instruction windows 210 or 211 has completed. When execution of an instruction block is complete, the instruction block is designated as “committed” and signals from the control outputs 295 can in turn can be used by other cores within the block-based processor 100 and/or by the control unit 160 to initiate scheduling, fetching, and execution of other instruction blocks. Both the first router 250 and the second router 270 can send data back to the instruction (for example, as operands for other instructions within an instruction block).

As will be readily understood to one of ordinary skill in the relevant art, the components within an individual core 200 are not limited to those shown in FIG. 2, but can be varied according to the requirements of a particular application. For example, a core may have fewer or more instruction windows, a single instruction decoder might be shared by two or more instruction windows, and the number of and type of functional units used can be varied, depending on the particular targeted application for the block-based processor. Other considerations that apply in selecting and allocating resources with an instruction core include performance requirements, energy usage requirements, integrated circuit die, process technology, and/or cost.

It will be readily apparent to one of ordinary skill in the relevant art that trade-offs can be made in processor performance by the design and allocation of resources within the instruction window (e.g., instruction window 210) and control unit 205 of the processor cores 110. The area, clock period, capabilities, and limitations substantially determine the realized performance of the individual cores 110 and the throughput of the block-based processor 100.

The instruction scheduler 206 can have diverse functionality. In certain higher performance examples, the instruction scheduler is highly concurrent. For example, each cycle, the decoder(s) write instructions' decoded ready state and decoded instructions into one or more instruction windows, selects the next instruction to issue, and, in response the back end sends ready events—either target-ready events targeting a specific instruction's input slot (predicate, left operand, right operand, etc.), or broadcast-ready events targeting all instructions. The per-instruction ready state bits, together with the decoded ready state can be used to determine that the instruction is ready to issue.

In some cases, the scheduler 206 accepts events for target instructions that have not yet been decoded and must also inhibit reissue of issued ready instructions. In some examples, instructions can be non-predicated, or predicated (based on a true or false condition). A predicated instruction does not become ready until it is targeted by another instruction's predicate result, and that result matches the predicate condition. If the associated predicate does not match, the instruction never issues. In some examples, predicated instructions may be issued and executed speculatively. In some examples, a processor may subsequently check that speculatively issued and executed instructions were correctly speculated. In some examples a misspeculated issued instruction and the specific transitive closure of instructions in the block that consume its outputs may be re-executed, or misspeculated side effects annulled. In some examples, discovery of a misspeculated instruction leads to the complete roll back and re-execution of an entire block of instructions.

Upon branching to a new instruction block, the respective instruction window(s) ready state is cleared (a block reset). However when an instruction block branches back to itself (a block refresh), only active ready state is cleared. The decoded ready state for the instruction block can thus be preserved so that it is not necessary to re-fetch and decode the block's instructions. Hence, block refresh can be used to save time and energy in loops.

### V. Example Stream of Instruction Blocks

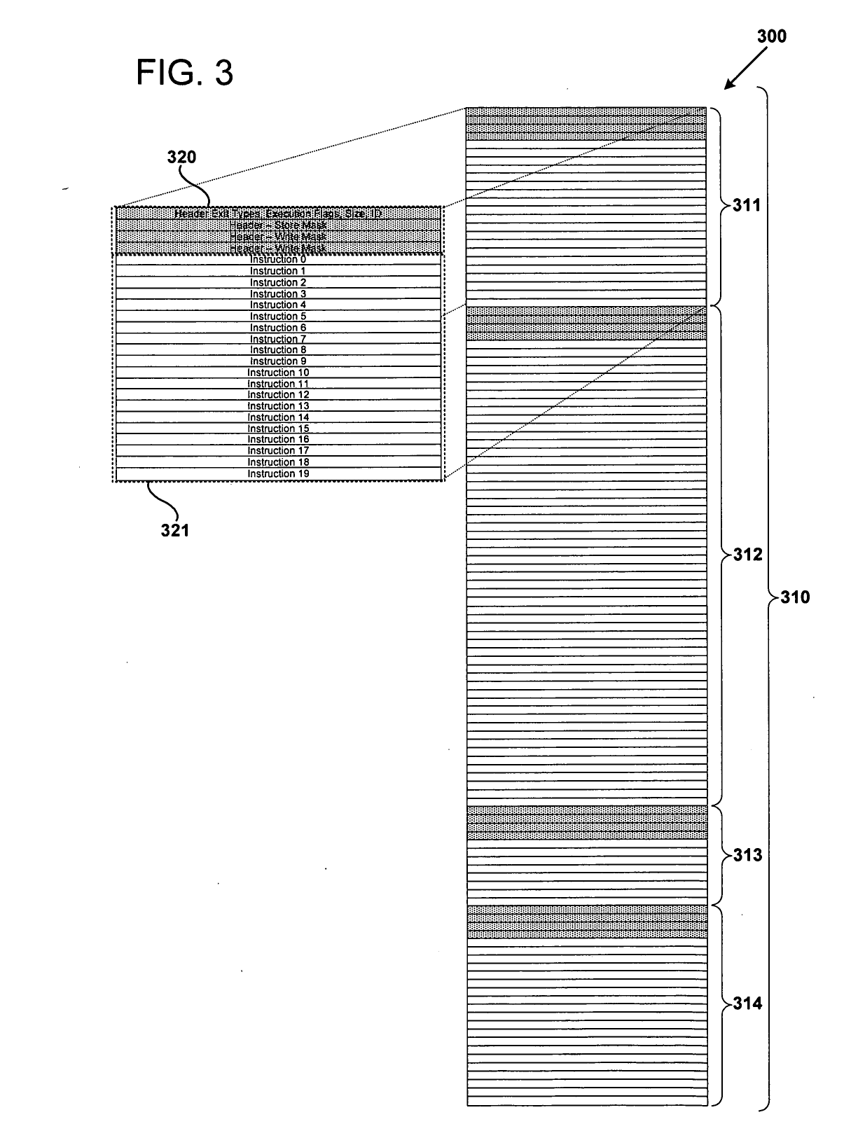

Turning now to the diagram 300 of FIG. 3, a portion 310 of a stream of block-based instructions, including a number of variable length instruction blocks 311-314 is illustrated. The stream of instructions can be used to implement user application, system services, or any other suitable use. For example, the stream of instructions can be executed according to a specified mode of operation. In the example shown in FIG. 3, each instruction block begins with an instruction header, which is followed by a varying number of instructions. For example, the instruction block 311 includes a header 320 and twenty instructions 321. The particular instruction header 320 illustrated includes a number of data fields that control, in part, execution of the instructions within the instruction block, and also allow for improved performance enhancement techniques including, for example branch prediction, speculative execution, lazy evaluation, and/or other techniques. The instruction header 320 also includes an indication of the instruction block size. The instruction block size can be in larger chunks of instructions than one, for example, the number of 4-instruction chunks contained within the instruction block. In other words, the size of the block is shifted 4 bits in order to compress header space allocated to specifying instruction block size. Thus, a size value of 0 indicates a minimally-sized instruction block which is a block header followed by four instructions. In some examples, the instruction block size is expressed as a number of bytes, as a number of words, as a number of n-word chunks, as an address, as an address offset, or using other suitable expressions for describing the size of instruction blocks. In some examples, the instruction block size is indicated by a terminating bit pattern in the instruction block header and/or footer.

The instruction block header 320 can also include one or more execution flags that indicate one or more modes of operation for executing the instruction block. For example, the modes of operation can include core fusion operation, vector mode operation, memory dependence prediction, and/or in-order or deterministic instruction execution.

In some examples of the disclosed technology, the instruction header 320 includes one or more identification bits that indicate that the encoded data is an instruction header. For example, in some block-based processor ISAs, a single ID bit in the least significant bit space is always set to the binary value 1 to indicate the beginning of a valid instruction block. In other examples, different bit encodings can be used for the identification bit(s). In some examples, the instruction header 320 includes information indicating a particular version of the ISA for which the associated instruction block is encoded.

The block instruction header can also include a number of block exit types for use in, for example, branch prediction, control flow determination, and/or branch processing. The exit type can indicate what the type of branch instructions are, for example: sequential branch instructions, which point to the next contiguous instruction block in memory; offset instructions, which are branches to another instruction block at a memory address calculated relative to an offset; subroutine calls, or subroutine returns. By encoding the branch exit types in the instruction header, the branch predictor can begin operation, at least partially, before branch instructions within the same instruction block have been fetched and/or decoded.

The instruction block header 320 also includes a store mask which identifies the load-store queue identifiers that are assigned to store operations. The instruction block header can also include a write mask, which identifies which global register(s) the associated instruction block will write. The associated register file must receive a write to each entry before the instruction block can complete. In some examples a block-based processor architecture can include not only scalar instructions, but also single-instruction multiple-data (SIMD) instructions, that allow for operations with a larger number of data operands within a single instruction.

Examples of suitable block-based instructions that can be used for the instructions 321 can include instructions for executing integer and floating-point arithmetic, logical operations, type conversions, register reads and writes, memory loads and stores, execution of branches and jumps, and other suitable processor instructions. In some examples, the instructions include instructions for configuring the processor to operate according to one or more of operations by, for example, setting/clearing one or more operation flags or storing data in a control register (e.g., operation mode register 167 or 207). In some examples, data such as the number of cores to allocate to core fusion or vector mode operations (e.g., for all or a specified instruction block) can be stored in a control register. In some examples, the control register is not architecturally visible. In some examples, access to the control register is configured to be limited to processor operation in a supervisory mode or other protected mode of the processor.

### VI. Example Block Instruction Target Encoding

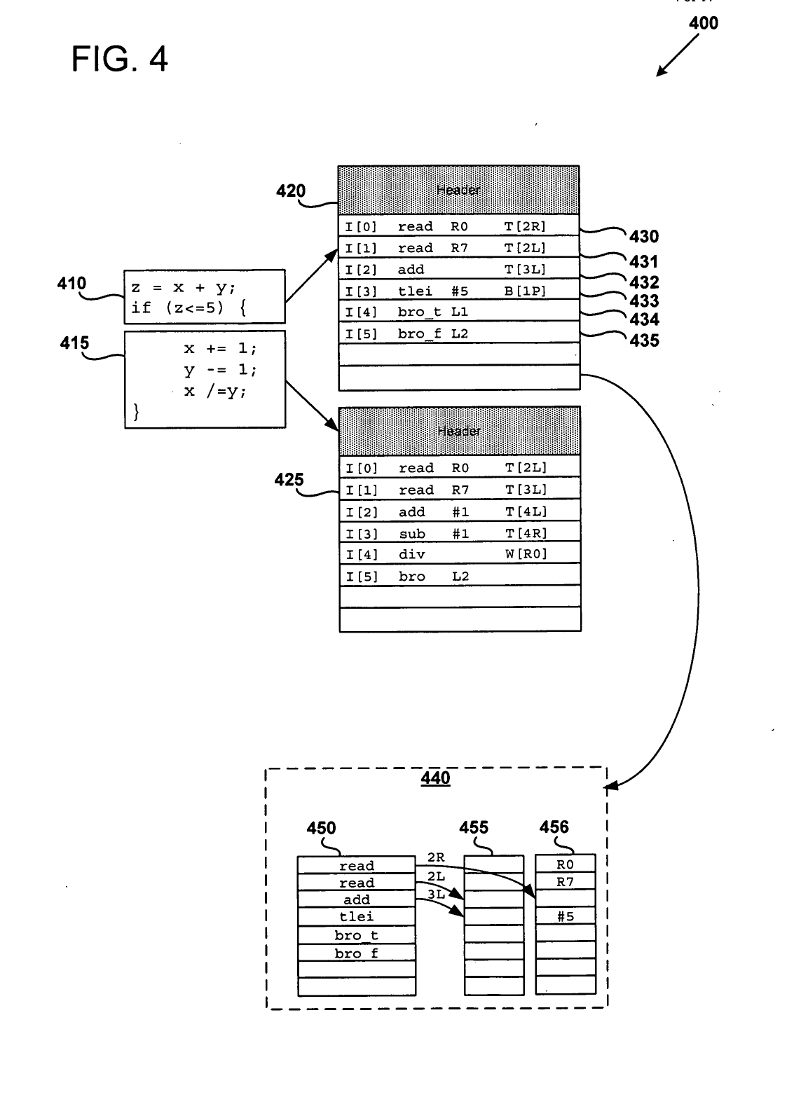

FIG. 4 is a diagram 400 depicting an example of two portions 410 and 415 of C language source code and their respective instruction blocks 420 and 425, illustrating how block-based instructions can explicitly encode their targets. The example instructions can be executed according to a specified mode of operation. In this example, the first two READ instructions 430 and 431 target the right (T[2R]) and left (T[2L]) operands, respectively, of the ADD instruction 432. In the illustrated ISA, the read instruction is the only instruction that reads from the global register file (e.g., register file 230); however any instruction can target, the global register file. When the ADD instruction 432 receives the result of both register reads it will become ready and execute.

When the TLEI (test-less-than-equal-immediate) instruction 433 receives its single input operand from the ADD, it will become ready and execute. The test then produces a predicate operand that is broadcast on channel one (B[1P]) to all instructions listening on the broadcast channel, which in this example are the two predicated branch instructions (BRO_T 434 and BRO_F 435). The branch that receives a matching predicate will fire.

A dependence graph 440 for the instruction block 420 is also illustrated, as an array 450 of instruction nodes and their corresponding operand targets 455 and 456. This illustrates the correspondence between the block instructions 420, the corresponding instruction window entries, and the underlying dataflow graph represented by the instructions. Here decoded instructions READ 430 and READ 431 are ready to issue, as they have no input dependencies. As they issue and execute, the values read from registers R0 and R7 are written into the right and left operand buffers of ADD 432, marking the left and right operands of ADD 432 “ready.” As a result, the ADD 432 instruction becomes ready, issues to an ALU, executes, and the sum is written to the left operand of the TLEI instruction 433.

### VII. Example Block-Based Instruction Formats

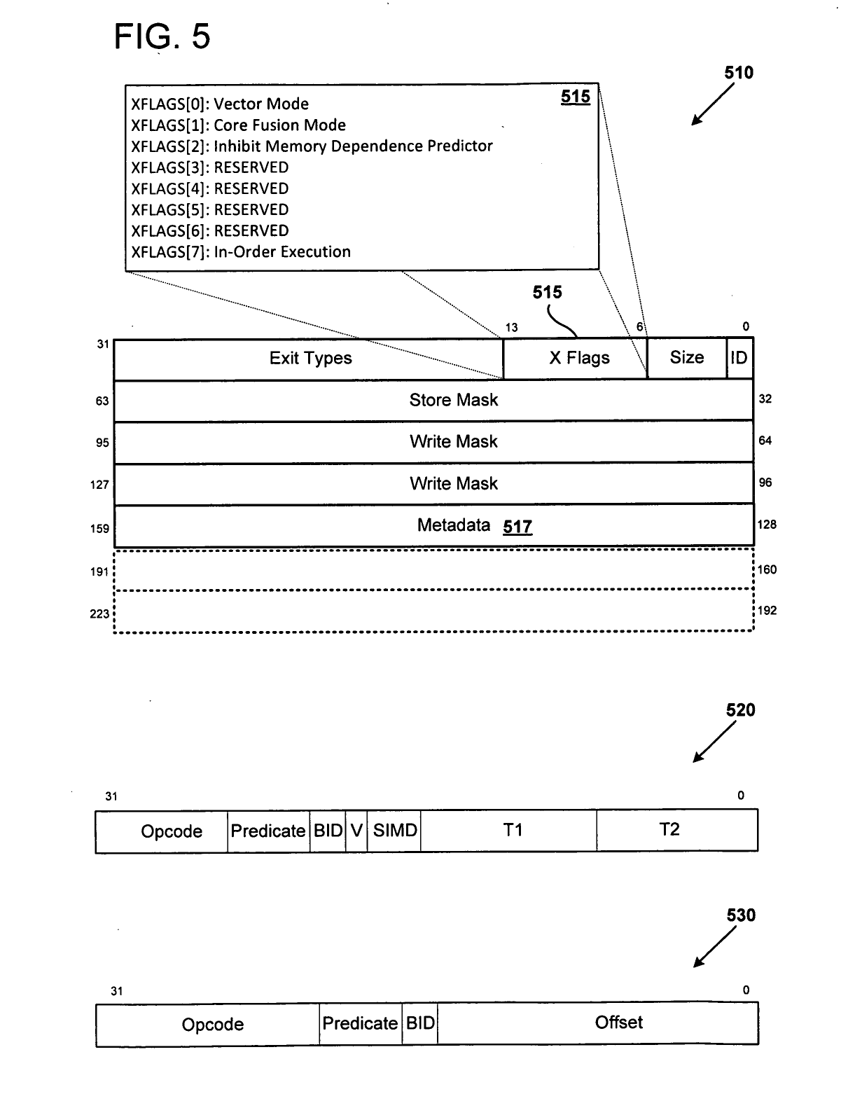

FIG. 5 is a diagram illustrating generalized examples of instruction formats for an instruction header 510, a generic instruction 520, and a branch instruction 530. The instruction formats can be used for instruction blocks executed according to a specified mode of operation. Each of the instruction headers or instructions is labeled according to the number of bits. For example the instruction header 510 includes five 32-bit words and is labeled from its least significant bit (lsb) (bit 0) up to its most significant bit (msb) (bit 159). As shown, the instruction header includes a write mask field, a store mask field, a number of exit type fields, a number of execution flag fields 515, an instruction block size field, and an instruction header ID bit (the least significant bit of the instruction header). The instruction header 510 further includes additional metadata 517 that further specifies operation of the instructions. In some examples, the metadata 517 is a fixed length (e.g., one or two words of data). In other examples, the metadata 517 can be of variable length.

The execution flag fields 515 depicted in FIG. 5 occupy bits 6 through 13 of the instruction block header 510 and indicate one or more modes of operation for executing the instruction block. For example, the modes of operation can include core fusion operation, vector mode operation, memory dependence prediction, and/or in-order or deterministic instruction execution. In some examples of the disclosed technology, bit 6 (XFLAGS[0]) indicates vector mode operation, bit 7 indicates core fusion mode, bit 8 indicates whether to inhibit a memory dependence predictor, and bit 13 (XFLAGS[7]) indicates whether to force deterministic execution (e.g., execution in sequential order, or in a not-strictly sequential order that does not vary based on data dependencies or other varying operation latencies). In some examples, the metadata 517 can include additional data further defining the mode(s) of operation. For example, the metadata 517 can indicate a number and/or topology of cores for core fusion operation.

The exit type fields include data that can be used to indicate the types of control flow instructions encoded within the instruction block. For example, the exit type fields can indicate that the instruction block includes one or more of the following: sequential branch instructions, offset branch instructions, indirect branch instructions, call instructions, and/or return instructions. In some examples, the branch instructions can be any control flow instructions for transferring control flow between instruction blocks, including relative and/or absolute addresses, and using a conditional or unconditional predicate. The exit type fields can be used for branch prediction and speculative execution in addition to determining implicit control flow instructions. In some examples, up to six exit types can be encoded in the exit type fields, and the correspondence between fields and corresponding explicit or implicit control flow instructions can be determined by, for example, examining control flow instructions in the instruction block.

The illustrated generic block instruction 520 is stored as one 32-bit word and includes an opcode field, a predicate field, a broadcast ID field (BID), a vector operation field (V), a single instruction multiple data (SIMD) field, a first target field (T1), and a second target field (T2). For instructions with more consumers than target fields, a compiler can build a fanout tree using move instructions, or it can assign instruction target operands to broadcast channels. Broadcasts support sending an operand over a lightweight network to any number of consumer instructions in a core. A sending instruction encodes a target channel and/or type (e.g., LOP, ROP, or PRED) to send broadcast data in one or both target fields (T1 and/or T2). A broadcast identifier filed (BID) can be encoded in the generic block instruction 520, and indicates that a channel on which the instruction receives a broadcast operand. In other examples, the BID field can further encode a type of incoming broadcast operand data.

While the generic instruction format outlined by the generic instruction 520 can represent some or all instructions processed by a block-based processor, it will be readily understood by one of skill in the art that, even for a particular example of an ISA, one or more of the instruction fields may deviate from the generic format for particular instructions. The opcode field specifies the operation(s) performed by the instruction 520, such as memory read/write, register load/store, add, subtract, multiply, divide, shift, rotate, system operations, or other suitable instructions. The predicate field specifies the condition under which the instruction will execute. For example, the predicate field can specify the value “true,” and the instruction will only execute if a corresponding condition flag matches the specified predicate value. In some examples, the predicate field specifies, at least in part, which is used to compare the predicate, while in other examples, the execution is predicated on a flag set by a previous instruction (e.g., the preceding instruction in the instruction block). In some examples, the predicate field can specify that the instruction will always, or never, be executed. Thus, use of the predicate field can allow for denser object code, improved energy efficiency, and improved processor performance, by reducing the number of branch instructions.

The target fields T1 and T2 specifying the instructions to which the results of the block-based instruction are sent. For example, an ADD instruction at instruction slot 5 can specify that its computed result will be sent to instructions at slots 3 and 10. Depending on the particular instruction and ISA, one or both of the illustrated target fields can be replaced by other information, for example, the first target field T1 can be replaced by an immediate operand, an additional opcode, specify two targets, etc.

The branch instruction 530 includes an opcode field, a predicate field, a broadcast ID field (BID), and an offset field. The opcode and predicate fields are similar in format and function as described regarding the generic instruction. The offset can be expressed in units of groups of four instructions, thus extending the memory address range over which a branch can be executed. The predicate shown with the generic instruction 520 and the branch instruction 530 can be used to avoid additional branching within an instruction block. For example, execution of a particular instruction can be predicated on the result of a previous instruction (e.g., a comparison of two operands). If the predicate is false, the instruction will not commit values calculated by the particular instruction. If the predicate value does not match the required predicate, the instruction does not issue. For example, a BRO_F (predicated false) instruction will issue if it is sent a false predicate value.

It should be readily understood that, as used herein, the term “branch instruction” is not limited to changing program execution to a relative memory location, but also includes jumps to an absolute or symbolic memory location, subroutine calls and returns, and other instructions that can modify the execution flow. In some examples, the execution flow is modified by changing the value of a system register (e.g., a program counter PC or instruction pointer), while in other examples, the execution flow can be changed by modifying a value stored at a designated location in memory. In some examples, a jump register branch instruction is used to jump to a memory location stored in a register. In some examples, subroutine calls and returns are implemented using jump and link and jump register instructions, respectively.

### VIII. Example Processor State Diagram

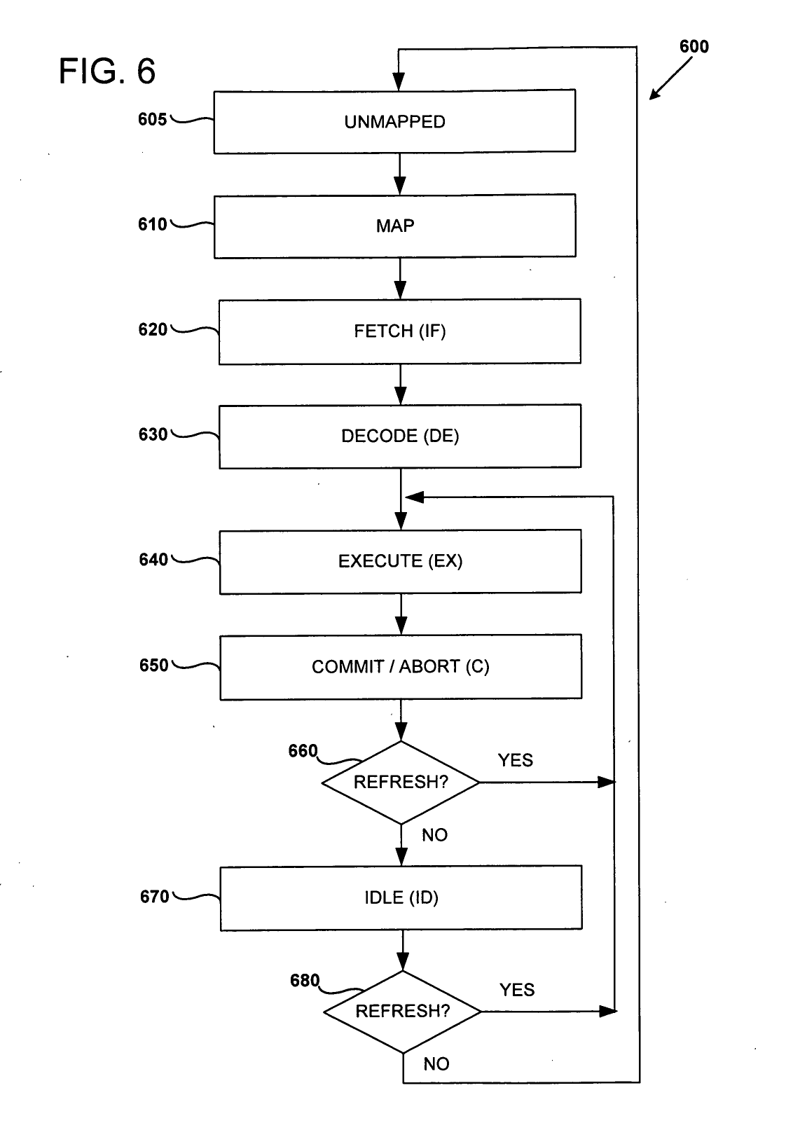

FIG. 6 is a state diagram 600 illustrating number of states assigned to an instruction block as it is mapped, executed, and retired. For example, one or more of the states can be assigned during execution of an instruction according to a specified mode of operation. It should be readily understood that the states shown in FIG. 6 are for one example of the disclosed technology, but that in other examples an instruction block may have additional or fewer states, as well as having different states than those depicted in the state diagram 600. At state 605, an instruction block is unmapped. The instruction block may be resident in memory coupled to a block-based processor, stored on a computer-readable storage device such as a hard drive or a flash drive, and can be local to the processor or located at a remote server and accessible using a computer network. The unmapped instructions may also be at least partially resident in a cache memory coupled to the block-based processor.

At instruction block map state 610, control logic for the block-based processor, such as an instruction scheduler, can be used to monitor processing core resources of the block-based processor and map the instruction block to one or more of the processing cores.

The control unit can map one or more of the instruction block to processor cores and/or instruction windows of particular processor cores. In some examples, the control unit monitors processor cores that have previously executed a particular instruction block and can re-use decoded instructions for the instruction block still resident on the “warmed up” processor core. Once the one or more instruction blocks have been mapped to processor cores, the instruction block can proceed to the fetch state 620.

When the instruction block is in the fetch state 620 (e.g., instruction fetch), the mapped processor core fetches computer-readable block instructions from the block-based processors' memory system and loads them into a memory associated with a particular processor core. For example, fetched instructions for the instruction block can be fetched and stored in an instruction cache within the processor core. The instructions can be communicated to the processor core using core interconnect. Once at least one instruction of the instruction block has been fetched, the instruction block can enter the instruction decode state 630.

During the instruction decode state 630, various bits of the fetched instruction are decoded into signals that can be used by the processor core to control execution of the particular instruction. For example, the decoded instructions can be stored in one of the memory stores 215 or 216 shown above, in FIG. 2. The decoding includes generating dependencies for the decoded instruction, operand information for the decoded instruction, and targets for the decoded instruction. Once at least one instruction of the instruction block has been decoded, the instruction block can proceed to execution state 640.

During the execution state 640, operations associated with the instruction are performed using, for example, functional units 260 as discussed above regarding FIG. 2. As discussed above, the functions performed can include arithmetical functions, logical functions, branch instructions, memory operations, and register operations. Control logic associated with the processor core monitors execution of the instruction block, and once it is determined that the instruction block can either be committed, or the instruction block is to be aborted, the instruction block state is set to commit/abort 650.

At the commit/abort state 650, the processor core control unit determines that operations performed by the instruction block can be completed. For example memory load store operations, register read/writes, branch instructions, and other instructions will definitely be performed according to the control flow of the instruction block. Alternatively, if the instruction block is to be aborted, for example, because one or more of the dependencies of instructions are not satisfied, or the instruction was speculatively executed on a predicate for the instruction block that was not satisfied, the instruction block is aborted so that it will not affect the state of the sequence of instructions in memory or the register file. Regardless of whether the instruction block has committed or aborted, the instruction block goes to state 660 to determine whether the instruction block should be refreshed. If the instruction block is refreshed, the processor core re-executes the instruction block, typically using new data values, particularly the registers and memory updated by the just-committed execution of the block, and proceeds directly to the execute state 640. Thus, the time and energy spent in mapping, fetching, and decoding the instruction block can be avoided. Alternatively, if the instruction block is not to be refreshed, then the instruction block enters an idle state 670.

In the idle state 670, the processor core executing the instruction block can be idled by, for example, powering down hardware within the processor core, while maintaining at least a portion of the decoded instructions for the instruction block. At some point, the control unit determines 680 whether the idle instruction block on the processor core is to be refreshed or not. If the idle instruction block is to be refreshed, the instruction block can resume execution at execute state 640. Alternatively, if the instruction block is not to be refreshed, then the instruction block is unmapped and the processor core can be flushed and subsequently instruction blocks can be mapped to the flushed processor core.

While the state diagram 600 illustrates the states of an instruction block as executing on a single processor core for ease of explanation, it should be readily understood to one of ordinary skill in the relevant art that in certain examples, multiple processor cores can be used to execute multiple instances of a given instruction block, concurrently.

### IX. Example Block-Based Processor and Memory Configuration

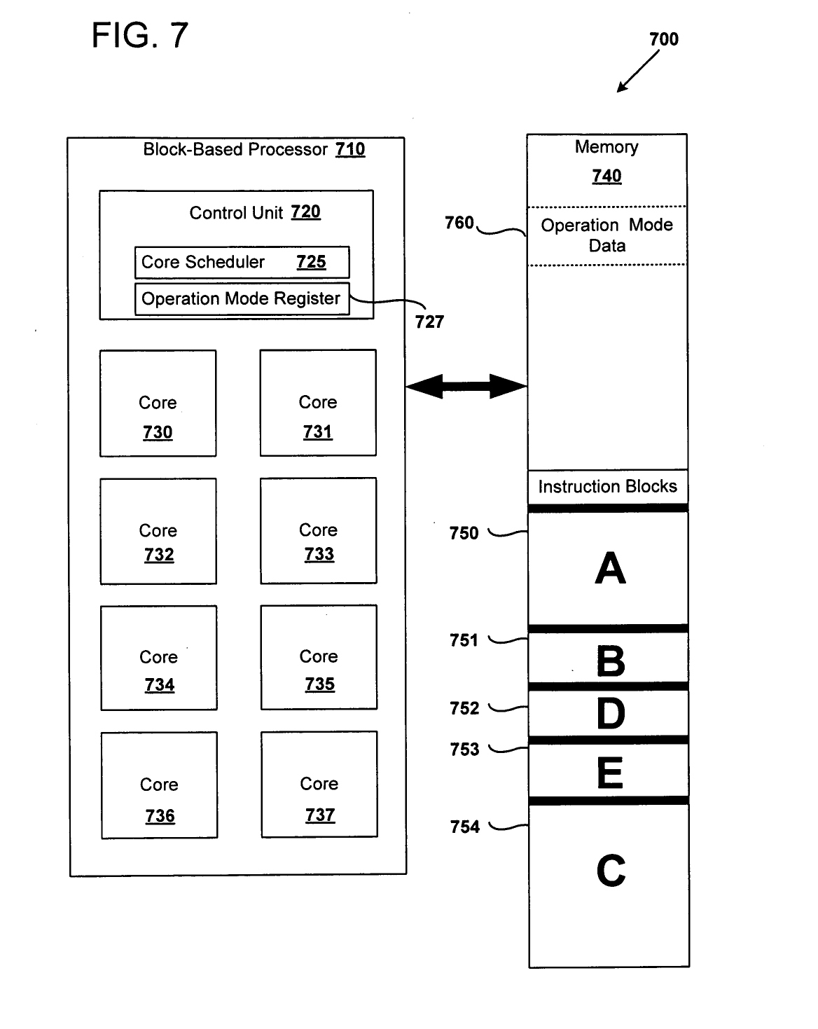

FIG. 7 is a diagram 700 illustrating an apparatus comprising a block-based processor 710, including a control unit 720 configured to execute instruction blocks according to data for one or more operation modes. The control unit 720 includes a core scheduler 725 and an operation mode register 727. The core scheduler 725 schedules the flow of instructions including allocation and de-allocation of cores for performing instruction processing, control of input data and output data between any of the cores, register files, memory interfaces and/or I/O interfaces. The control unit 720 also includes an operation mode register 727, which can be used to store data indicating one or more mode of operations for an instruction block.

The block-based processor 710 also includes one or more processor cores 730-737 configured to fetch and execute instruction blocks and a control unit 720, when a branch signal indicating the target location is received from one of the instruction blocks. The illustrated block-based processor 710 has up to eight cores, but in other examples there could be 64, 512, 1024, or other numbers of block-based processor cores. The block-based processor 710 is coupled to a memory 740 which includes a number of instruction blocks 750-755. In some examples of the disclosed technology, an operation mode data table 760 can be stored in memory, or built dynamically at run time, to indicate operation mode(s) for executing the instruction blocks 750-754, in lieu of, or in addition to, the operation mode register 727.

### X. Example Method of Configuring Processor for a Selected Operation Mode

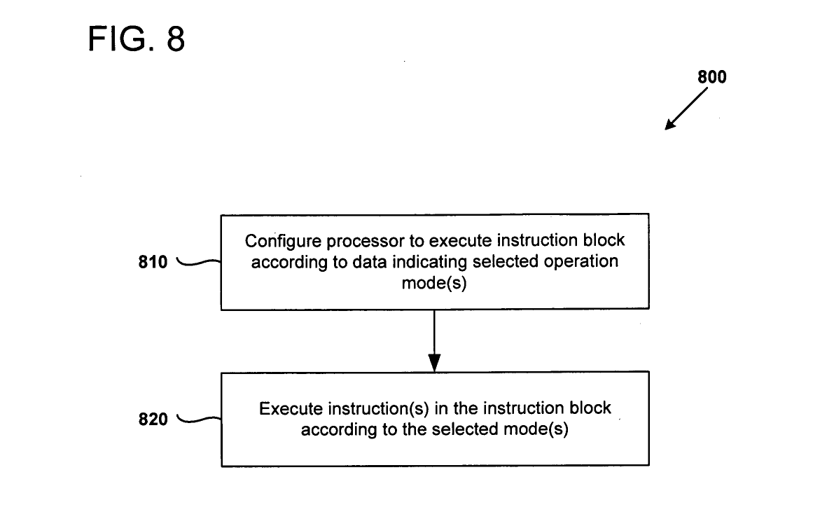

FIG. 8 is a block diagram 800 outlining an example method of configuring a processor to operate according to selected operation modes, as can be performed in certain examples of the disclosed technology. For example, the block-based processor 100 described above, can be configured to perform the method of FIG. 8.

At process block 810, the processor is configured to execute an instruction block according to data indicating one or more selected operation modes. For example, an instruction block header can be decoded for a block-based processor instruction block that includes one or more fields indicating one or more selected operation modes. The processor then configures at least one of its processor cores to execute instructions in the instruction block according to a mode of operation specified by one or more of the fields. The modes of operation that can be performed include, but are not limited to: core fusion operation, vector mode operation, memory-dependence prediction operation, and/or in-order execution operation. In some examples, when at least one of the specified modes is a core fusion operation, the field corresponding to the specified mode can indicate a number of cores of the block-based processor to allocate to execute of the associated instruction block. In some examples, the core is configured to execute instructions according to two or more operation modes. For example, the core can be configured to perform core fusion operations and to enable or disable memory dependence prediction. Alternatively, for example, the processor can be configured for core fusion operation and in-order execution operations. In some examples, data indicating one or more of the specified operation modes can be stored in a location other than an instruction block header, for example by executing a particular instruction of an instruction block, by storing a value in a designated register or memory location, or other suitable means for providing data indicating the operation mode. Once the processor is configured to execute the instruction block, the method proceeds to process block 820.

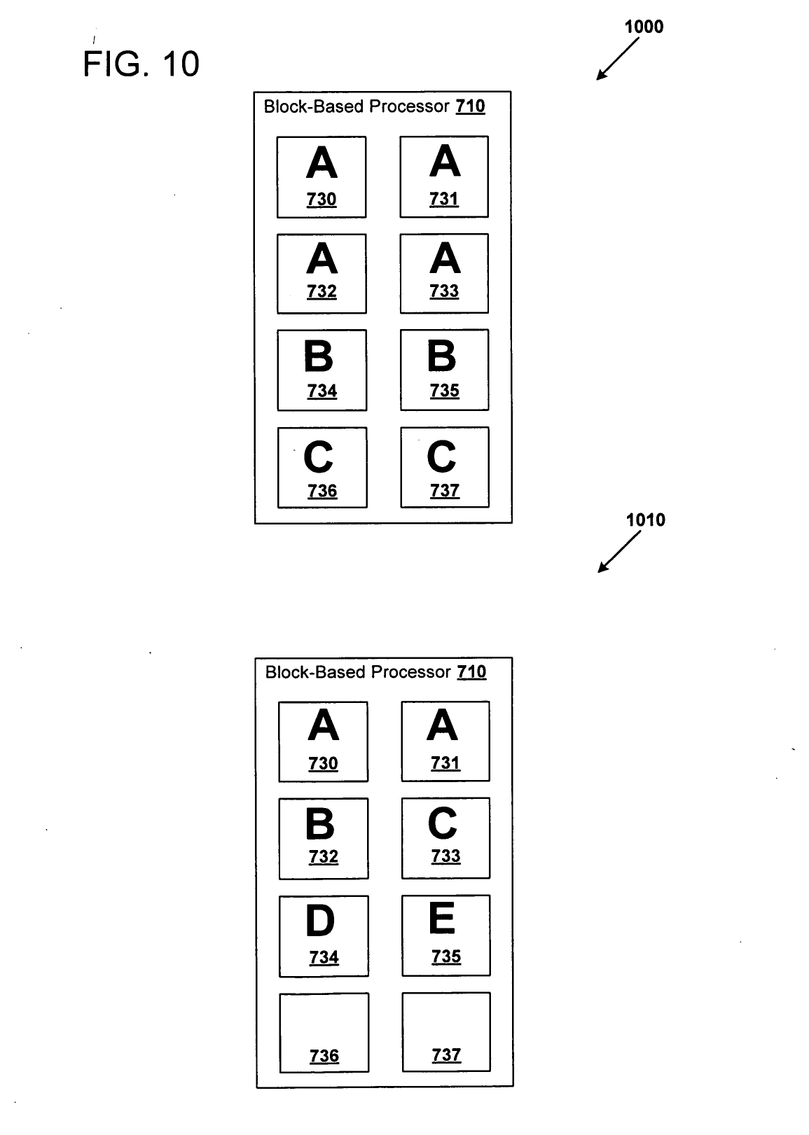

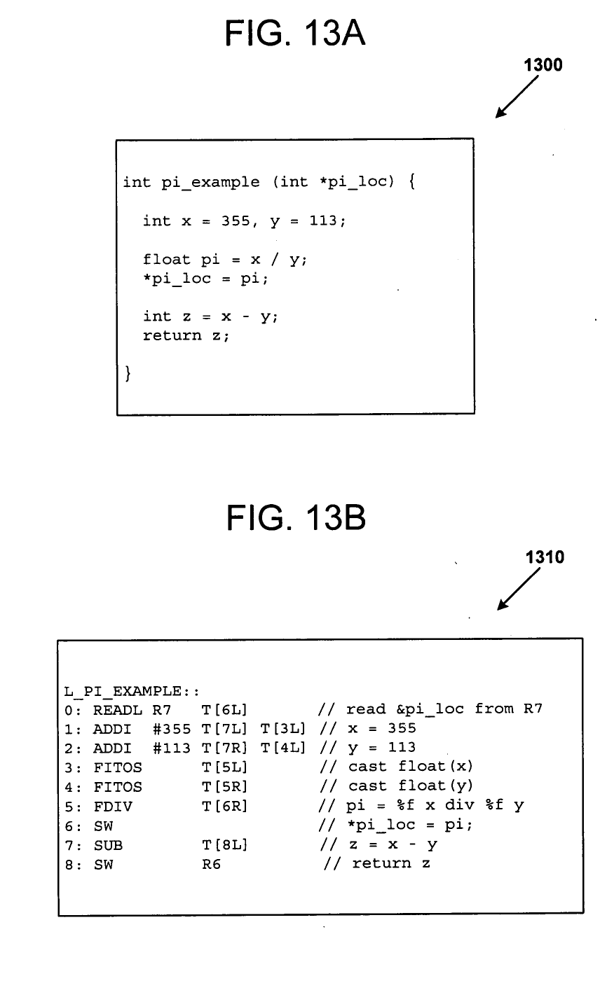

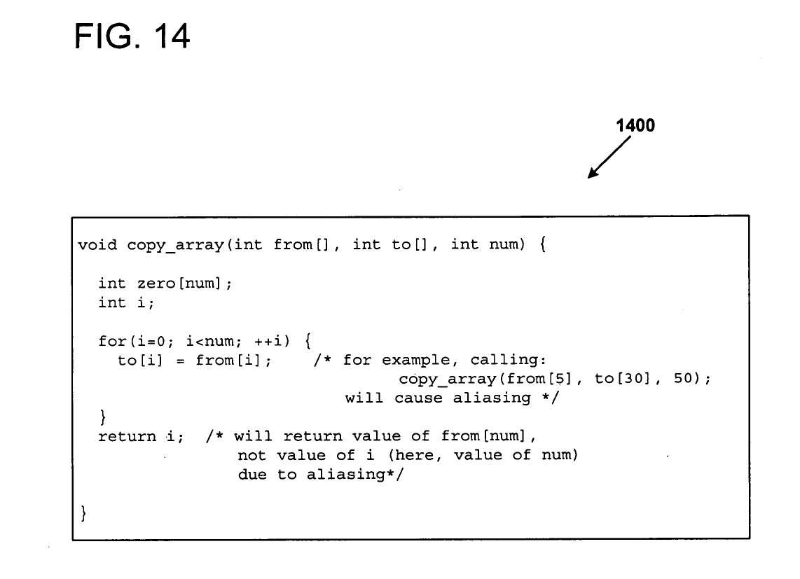

At process block 820, the instructions in the instruction block are executed according to the operation mode selected at process block 810. For example, one or more of the processor cores depicted in FIG. 1, 2, or 7 can be configured to execute the instructions according to the selected operation mode which include, but are not limited to, core fusion operation, vector mode operation, memory-dependence prediction operation, and/or in-order execution operation. The example code discussed below regarding FIGS. 13A, 13B, 14 and/or 15 can be executed using the method of FIG. 8, as well as the core fusion and vector mode operations discussed below regarding FIGS. 10-12.

### XI. Example Method of Configuring Processor for a Selected Operation Mode

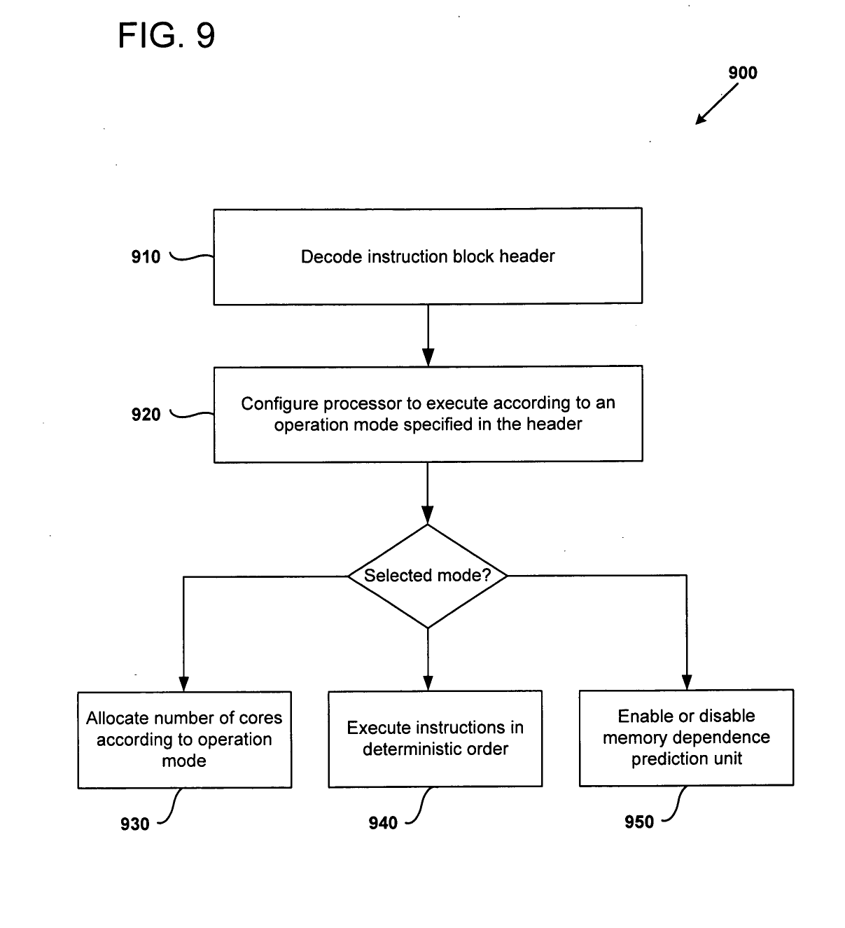

FIG. 9 is a flowchart 900 outlining an example method of configuring a processor to execute according to an operation mode, as can be performed in certain examples of the disclosed technology. For example, the block-based processor 100 of FIG. 1 can be used to perform the depicted method.

At process block 910, an instruction block header is decoded that includes one or more fields including data to indicate processor mode operation. For example, the fields can include flags designated as indicating various operation modes and/or parameters for operation modes such as the number of cores to allocate for execution of the instruction block. After the instruction block decoder has been decoded, the method proceeds to process block 920.

At process block 920, a block-based processor is configured to execute the associated instruction block instructions according the specified operation modes in the header. The process determines which of one or more operation modes have been designated, and proceeds to an appropriate one or more of the illustrated process blocks 930, 940, and/or 950, accordingly. In some examples, the block-based processor is configured to execute according to the core fusion and/or vector operation modes as discussed regarding process block 930. In some examples, the block-based processor is configured to execute according to the deterministic order operation modes as discussed regarding process block 940. In some examples, the block-based processor is configured to execute according to enabling or disabling a memory dependence prediction unit operation modes as discussed regarding process block 950. In some examples, the block-based processor is configured to operating according either: the modes of both process blocks 930 and 940, the modes of both process blocks 930 and 950, the modes of both process blocks 940 and 950, or the modes of process blocks 940, 940, and 950.

At process block 930, a number of cores are allocated for executing the instruction block according to the operation mode determined from the decoded instruction block header at process block 910. For example, the number of cores can be used to execute the instruction block using core fusion and/or for vector mode operations. In some examples, the number of cores allocated to the instruction block can be varied at run time dynamically.

A. Example Illustrating Core Fusion

FIG. 10 is a diagram illustrating two configurations of the block-based processor 710 according to a selected mode of operation, as can be performed in certain examples of the method illustrated in the flow chart 900. In the first configuration 1000, a number of cores of the block-based processor 710 have been executed to allocating blocks of instructions. For example, instruction block A has been allocated to execute on processor cores 730-733. Instruction block B has been allocated to processor cores 734 and 735, and instruction block C has been allocated to processor cores 736 and 737. Thus, more than one processor core can be allocated for performing execution of a block of instructions based on an operation mode (e.g., as specified with a flag in an instruction header, by using a processor instruction, encoded within an instruction, or stored in a designated register or memory).

In some examples, the number of cores that are allocated to an instruction block can be specified with the data that indicates the selected operation mode. For example, the instruction block header for an instruction block can specify that the block should be allocated to 2, 3, 4, or more processor cores. In other examples, the number of processor cores allocated to execute an instruction block is determined by the processor control unit or scheduler. For example, a particular instruction block can be allocated to a dynamically-determined number of cores based on performance statistics or the number of currently available cores within the processor. In some examples, the use of such fused cores can be used to enhance performance by, for example, allowing for speculative execution of an instruction block.

A second diagram 1010 illustrates another possible allocation of processor cores according to a selected one or more operations modes. In the example configuration of the diagram 1010 the mode of operation flag specifies that instruction block A is allocated two cores 730 and 731, while instruction blocks B, C, D, and E are each allocated to a single processor core (732-735), respectively.

The allocation of two or more cores for the execution of a single instruction block is an example of “core fusion.” In some examples of core fusion, data indicating the mode of operation indicates a number of cores with which to execute the instruction block. After executing and committing the instruction block at least once, the data indicating the operation mode can be changed to indicate a second, different number of cores to allocate for executing the instruction block. Based on changing the number of allocated cores, the processor can execute at least one instruction of the instruction block using the second number of cores indicated by the changed data. For example, data indicating the number of cores according to a core fusion mode of operation can be stored in a designated register within a block-based processor. In other examples, the data changed can be stored at a designated memory location. In other examples, data indicating the number of cores to allocate is stored in an instruction block header, and the data in the instruction block header can be changed between different instances of executing the instruction block in a fashion similar to self-modifying code. In other examples, the mode of operation can be designated by executing a processor instruction and an operand of this target of this processor instruction is changed in order to change the number of cores that are fused and used to execute the instruction block.

Thus, core fusion can be used to enhance performance of a block-based processor by allocating additional functional units from two or more cores to an instruction block.

B. Examples Illustrating Vector Modes of Operation

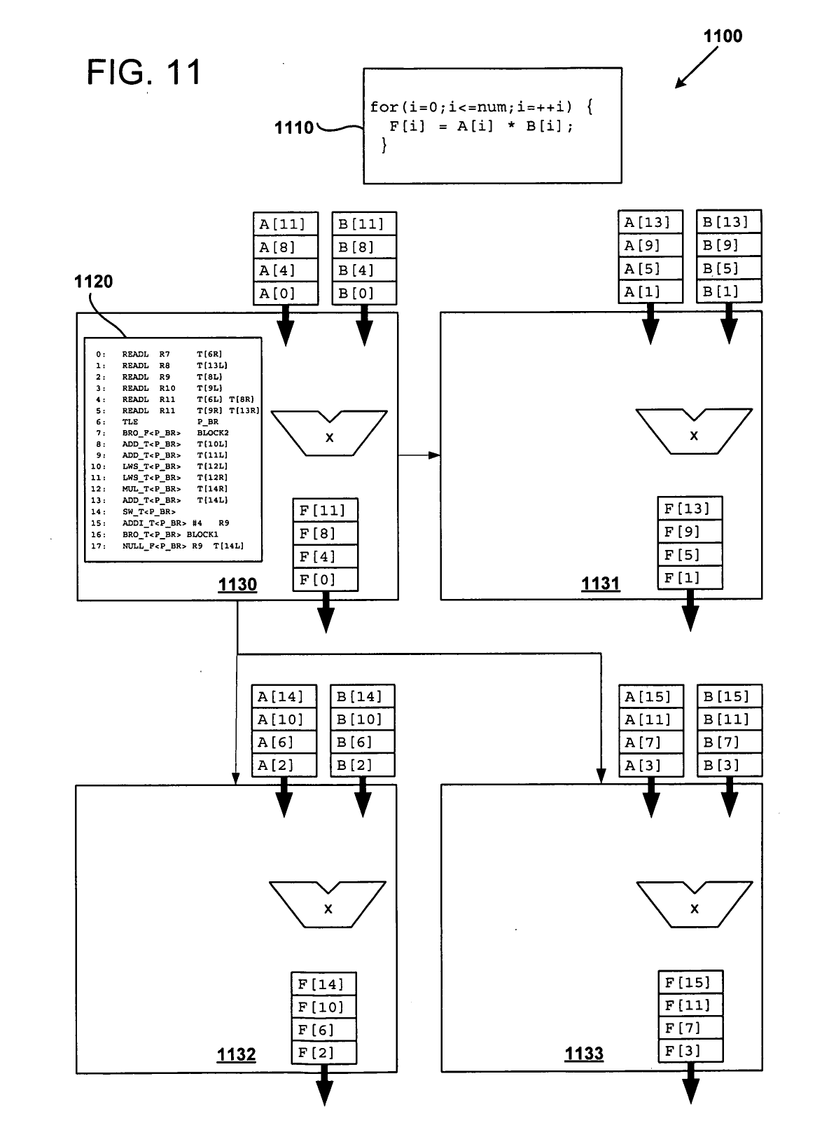

FIG. 11 is a diagram 1100 that outlines operation of a number of processor cores 730-733 while executing a portion of vectorized code 1110, which is reproduced below as Table 1. A processor can be configured for vector mode operation in certain examples of the method illustrated in the flow chart 900. As shown, the vectorized code 1110 multiplies two vectors A and B and places the result in a third vector F. The vector operation can be distributed amongst a number of processor cores. In the example shown, the operation has been distributed to four processor cores, but other numbers of course can be used, for example: 2, 8, 16, or other suitable number of cores. The portion of vectorized code 1110 is compiled and transformed into machine code 1120, which is also reproduced below as Table 2. In the configuration of FIG. 11, the machine code for the vector portion of the code is executing with a single execution lane 1130 of a processor core. The master lane 1130, in turn, directs execution of instructions on the other three follower cores 1131, 1132, and 1133. Thus, execution of the control flow is only performed with the single execution lane 1130, while appropriate control signals are sent to the other follower cores to perform vector processing.

TABLE 1

for(i=0;i<=num;i=++i) {

F[i] = A[i] * B[i];

}

TABLE 2
BLOCK0:
0: ...
...

| | | | |
|---|---|---|---|
| N−1: | ADDI | #0 R9 | // i=0 |
| N: | BRO | BLOCK1 | // branch to BLOCK1 |

----------
BLOCK1:

| 0: | READL R7 | T[6R] | | // load num |
|---|---|---|---|---|
| 1: | READL R8 | T[13L] | | // load &F |
| 2: | READL R9 | T[8L] | | // load &A |
| 3: | READL R10 | T[9L] | | // load &B |
| 4: | READL R11 | T[6L] T[8R] | | // load i (first 2 targets) |
| 5: | READL R11 | T[9R] T[13R] | | // load i (last 2 targets) |
| 6: | TLE | P_BR | | // i <= num ? |
| 7: | BRO_F<P_BR> | BLOCK2 | | // break; branch |
| | | | | // to next instruction block |
| 8: | ADD_T<P_BR> | T[10L] | | // calculate &A[i] |
| 9: | ADD_T<P_BR> | T[11L] | | // calculate &B[i] |
| 10: | LWS_T<P_BR> | T[12L] | | // load A[i] |
| 11: | LWS_T<P_BR> | T[12R] | | // load B[i] |
| 12: | MUL_T<P_BR> | T[14R] | | // F = A[i] * B[i]; |
| 13: | ADD_T<P_BR> | T[14L] | | // calculate &F[i] |
| 14: | SW_T<P_BR> | | | // F[i] = F |
| 15: | ADDI_T<P_BR> | #4 | R9 | // ++i (vectorized by 4) |

| 16: | BRO_T<P_BR> BLOCK1 | | // continue back to top of |
|---|---|---|---|
| | | | loop |
| 17: | NULL_F<P_BR> | R9 T[14L] | // Nullify certain ops if |

// predicate is not taken

As shown in FIG. 11, the vectorized operations have been distributed such that every fourth element of the vector is executed on a particular “lane” of a processor core. Each lane has an assigned functional unit for performing vectorized operation. For example the master execution lane 1130 will process elements numbers 0, 4, 8, 12 of vectors A, B, and F. Similarly, second lane 1131 will perform operations on elements numbers 1, 5, 9, 13, etc. of the vectors A, B, F.

While the distribution of processing of vector elements is shown in one way in FIG. 11, other distributions of vector operations are possible, as will be readily understood to one of ordinary skill in the relevant art. For example, vectorized operation can be combined with core fusion. In such examples, each fused processor core is assigned to a portion of the elements of a vector. One of the processor cores is designated a master core, and control flow is determined based on the master core, similar to the master execution lane example discussed above.

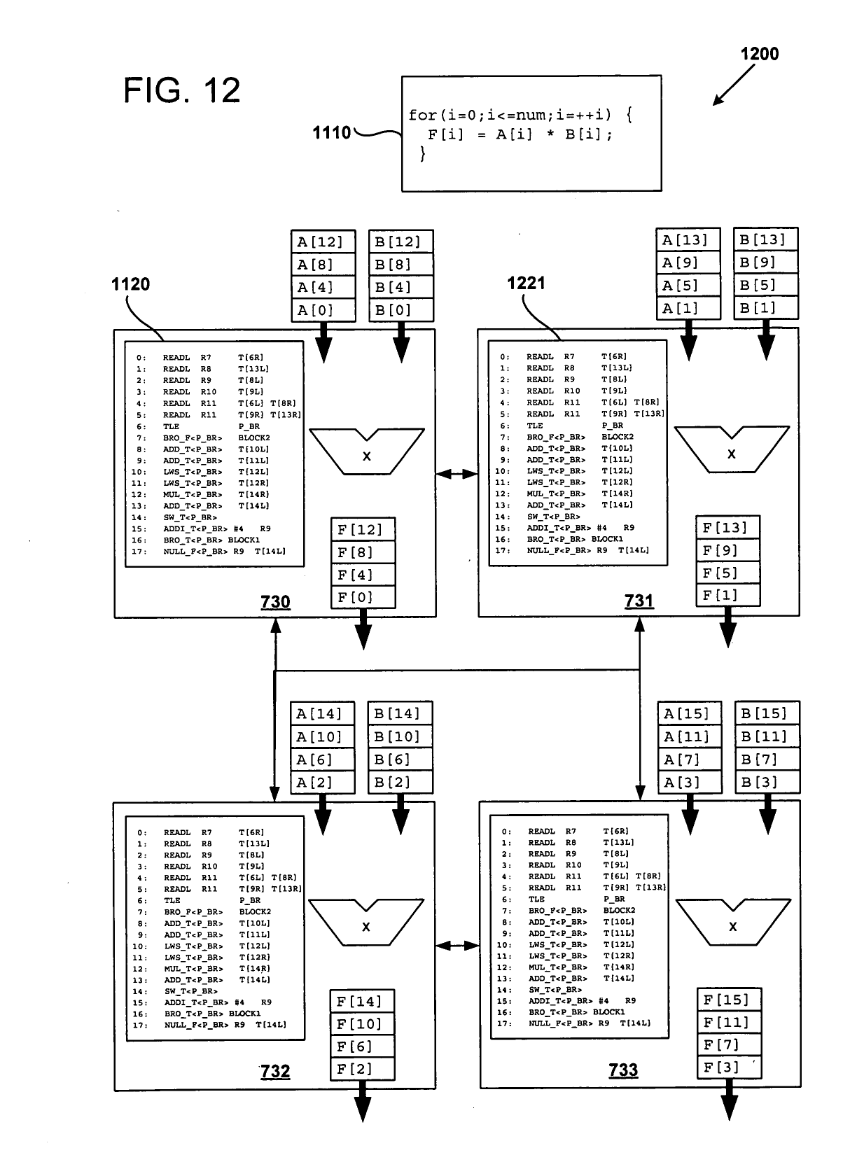

FIG. 12 is a diagram 1200 illustrating another configuration for performing vector mode operation using a block-based processor according to a mode of operation. As shown, a portion of the vector code 1110 has been compiled into machine code (vector machine code 1120. In the illustrated example, however, the machine code is duplicated (e.g., as duplicate vector machine code 1221) and executed on each of the processor cores 730-733. Thus, execution of control flow is performed on each individual processor core. Each of the processor cores 730-733 can, however, communicate with each other (e.g., by sending control signals) in order to synchronize operation of each core. For example, operations such as memory loads and stores, and register loads and stores, may not be executed concurrently in some examples. Thus, the communication can be used to synchronize the vector operations.

It will be readily understood to one of ordinary skill in the relevant art that designation of vector mode operation can be implemented using similar techniques such as those used for core fusion, as discussed above. For example, a mode of operation can be specified in an instruction block header, using a processor instruction, or by storing a value in a designated register or memory location. Further, the number of cores allocated to vector mode operation can be adjusted dynamically at run time and so the number of cores allocated can be adjusted from one core up to the maximum number of cores available to the processor, depending on the particular implementation.

At process block 940, instructions in the instruction block are executed in a deterministic order as specified in the instruction block header. In some examples, the deterministic order is the sequential order in which the instructions are arranged within the instruction block. In other examples, other criteria are used to determine the deterministic order. In some examples, the mode of operation causes execution of the block of instructions in a single step manner while a software debugger is being executed by the processor. Thus, by enabling deterministic instruction execution, operations such as debugging can be simplified.

C. Example Execution of Instruction Block in a Deterministic Order

FIG. 13A includes a portion of source code 1300 for a function named pi_example, while FIG. 13B includes a portion of corresponding assembly code 1310 (which can be converted to corresponding machine code for execution) for a block-based processor based on the example function, which are reproduced below as Tables 3 and 4, respectively.

TABLE 3

int pi_example (int *pi_loc) {

int x = 355, y = 113;
float pi = x / y;
*pi_loc = pi;
int z = x − y;
return z;

}

As shown in FIG. 13A (Table 3), two integers x and y are divided to generate a floating point number pi which is stored at the location pi_loc in memory. The integers x and y are also used to generate integer z which is the return value of the function pi_example.

TABLE 4
L_PI_EXAMPLE:

| 0: READL | R7 | T[6L] | // read &amp;pi_loc from R7 |
|---|---|---|---|
| 1: ADDI | #355 | T[7L] T[3L] | // x = 355 |
| 2: ADDI | #113 | T[7R] T[4L] | // y = 113 |

| 3: FITOS | T[5L] | // cast float(x) |
|---|---|---|
| 4: FITOS | T[5R] | // cast float(y) |
| 5: FDIV | T[6R] | // pi = %f x div %f y |
| 6: SW | | // *pi_loc = pi; |
| 7: SUB | T[8L] | // z = x − y |
| 8: MOV | R6 | // write z to global register |

| | |
|---|---|
| 9: RET | // return |

Turning now to FIG. 13B (Table 4), a number of block-based processor instructions are assigned at instruction numbers 0-8. It should be noted, however, that in certain examples of the disclosed technology, individual instructions within an instruction block need not execute in the sequential order shown. Rather, any of the instructions for the block-based processor can execute once their input operands, and any associated predicates, are available. For example, for the assembly code 1310 shown, it is highly likely that machine code instructions number 7 and 8 can initiate or even complete execution before one or more of the floating point instructions 3-5 and the dependent store instruction number 6 have completed.

While allowing the instructions to execute as soon as their operands and predicates are available can improve performance, it can also lead to more difficult debugging for the programmer. For example, when a programmer is single-stepping through individual instruction block instructions for example, with the aid of a debugger program, execution could proceed in this order: 0, 1, 2, 7, 8, 3, 4, 5, 6. Such out-of-order execution can be confusing. Further, in other examples, differences in memory latency and instruction latency can lead to certain instructions being executed out of the sequential order in which they appear in the instruction block. Moreover, not only can the instructions be executed out of their sequential order, but the instructions may not execute in a deterministic fashion. In other words, depending on the state of the systems cache, main memory, and/or virtual memory, the same instruction block can be executed in more than one order, even for the same variable and memory values.

A processor can be configured to enable or disable certain aspects of deterministic execution, for examples, according to certain examples of the method illustrated in the flow chart 900. In certain examples of the disclosed technology, an operation mode is specified that indicates a sequential order in which instructions of the block of instructions are to be executed. For example, the operation mode can indicate that the processor is to execute a particular instruction block in strict sequential order: 0, 1, 2, 3, etc. In some examples, the execution is performed according to a deterministic order that does not match the sequential ordering of the instruction in the instruction block. For example, such a deterministic ordering could execute register reads first, followed by memory loads, followed by arithmetic instructions, followed by memory writes, and followed by register writes. In some examples, the deterministic ordering is designated with data stored in a memory, such as data generated by a debugger that is included with the executed binary code. As will be readily understood to one of ordinary skill in the relevant art, other methods can be employed to determine a deterministic order for executing instructions in an instruction block. In some examples, the instructions in the block of instructions are executed in a single-step manner according to a specified order, which a software debugger is being executed by the processor. Such single-step debugging allows a user to provide input before the processor proceeds to execute the next instruction. In some examples, the software debugger causes execution of the instructions to proceed in lockstep. In other words, each of the cores will execute one instruction in a synchronized fashion with respect to the other cores operating in lockstep.

In some examples, a compiler emitting instructions determines possible deadlock situations and orders instructions and/or dependencies in the instruction block to avoid deadlock when the instructions are executed in sequential order. In other examples, the processor control unit detects deadlock situations when performing single-step debugging and flushes the block or takes other action to prevent deadlock.

D. Example of Enabling and Disabling a Memory Dependence Prediction Unit

At process block 950, a memory-dependence prediction unit can be enabled or disabled, as can be performed in certain examples of the method illustrated in the flow chart 900. For example, code that exhibits memory aliasing, or code that is accessing memory mapped I/O, can be configured to disable the memory-dependence prediction unit, thereby saving resources and avoiding thrashing during execution. Memory dependence prediction can be enabled in order to allow for higher performance of the processor and processor cores. In some examples of the disclosed technology, memory dependence prediction is only performed for instructions that are ready to execute, but not for predicated instructions whose conditionals have not yet been evaluated. In other examples, a control unit analyzes dependencies for memory load and store operations, and predicates associated with the analyzed memory load and store operations, allowing a processor core to speculatively execute instructions before all predicates have been determined. The processor core is further configured to monitor the memory loads and store operations to avoid read and/or write hazards due to, for example, executing an instruction that loads from a memory location before an instruction that writes to the same memory location is executed, contrary to the order specified by the semantics of the program. In some examples, a compiler configured to emit block-based instructions can “hoist” certain predicated load instructions by removing the predicate condition, thereby causing the load instruction to always execute.

Memory aliasing (e.g., reads and writes to the same memory location that are not determinable at compile time) and memory-mapped I/O techniques can also cause read/write hazards. Such hazards can result in pipeline flushes, resulting in re-execution of the code after one or more predicates are determined. For some portions of code, it can be determined (e.g., by compiler analysis or designation by a programmer) that memory dependence predication should be disabled for the portions of code, thereby avoid performance loss and energy waste due to memory dependence hazards and pipeline flushes.

FIG. 14 is a source code excerpt 1400 of a function that can exhibit memory aliasing when compiled and executed on a processor according to certain examples of the disclosed technology. As shown, because the compiler does not know the addresses of the arrays named from[ ] and to[ ], at compile time, and those two arrays may overlap in memory, it is possible for the copy operation illustrated to read and write to the same location. Further, due to the arrangement of the array named zero[ ] and the integer i as declared in the copy_array function, a memory access past the allocated space for the array named zero can overwrite the value of the integer i, if the integer is stored in memory next to the array named zero[ ]. Thus, these are two example situations where memory aliasing can occur. Because such memory aliasing can result in poor performance when memory dependence prediction is used, it can be desirable to disable such prediction in certain examples of the disclosed technology.

A compiler, which can be used to transform the source code excerpt 1400 into machine code executable on a processor, for example a block-based processor, can identify certain aliasing situations, including those similar to the example shown and set a flag to indicate that the operation mode for the instruction block or blocks implementing the code to be disabled. In some examples, the programmer can manually identify aliasing situations and provide instructions to the compiler using, for example, a pragma statement. Once the compiler executes and transforms source code and/or object code into executable code, the executable code will include at least one execution mode flag indicating an operation mode to enable or disable memory-dependence prediction. In some examples, the operation mode is indicated by one or more bits in an instruction block header. In other examples, memory dependence prediction enable is indicated in an instruction, such as a memory load or store instruction, or can be indicated by executing a separate instruction to enable or disable the operation mode. In some examples, a register or memory location can be set with a flag that indicates the appropriate operation mode.

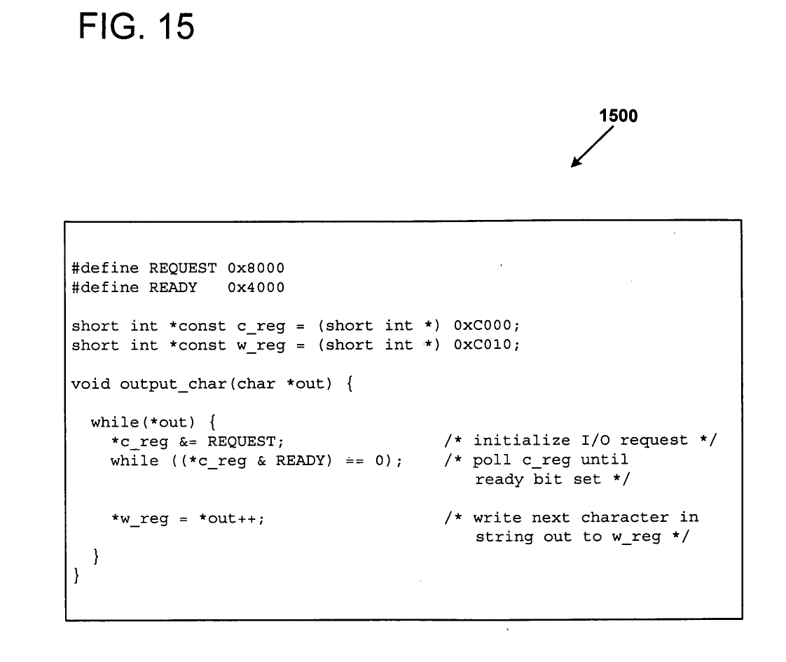

FIG. 15 includes an example of source code 1500 that can be compiled and executed on a processor according to the disclosed technology, including block-based processors. The source code 1500 includes code to perform I/O operations using memory-mapped addressing. For example, the pointer c_reg is used to initialize an I/O request, and then the pointer is further used to poll the same memory location to determine the connected I/O device is ready to receive data. Once a ready indication is received within the wild loop, the function proceeds to write another character at the location indicated by the pointer w_reg. In such examples, it is often desirable to disable memory optimizations, including memory dependence prediction, in order to ensure performant operation of the processor. Memory dependence prediction can be enabled or disabled using similar techniques to those discussed above regarding FIG. 14, including setting a flag in an instruction block header, executing an instruction to set the operation mode, with a bit of instruction, and/or by storing a value in a designated register or memory address.

### XII. Example Method of Generating Block-Based Executable Instructions

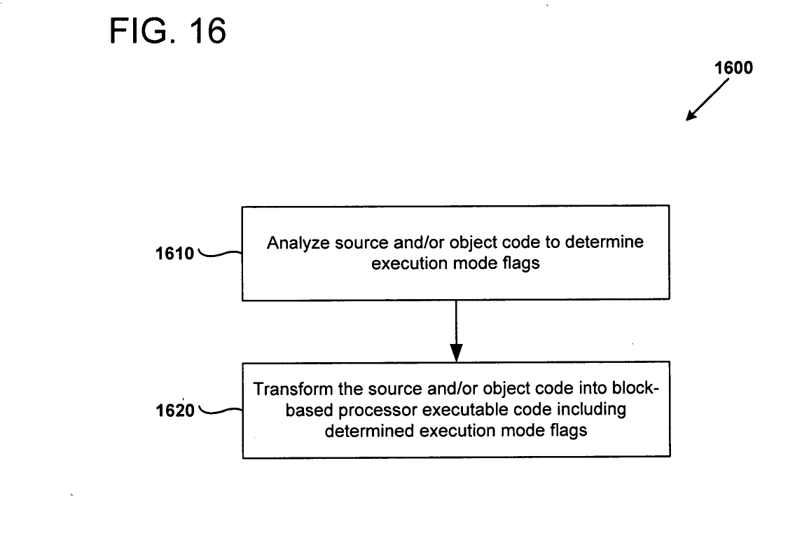

FIG. 16 is a flowchart 1600 outlining a method of compiling source and/or object code into executable code for a block-based processor, as can be performed in certain examples of the disclosed technology. For example, the method can be performed using a block-based processor, or a general-purpose processor that includes instructions for performing the disclosed method.

At process block 1610, source code and/or object code for a block-based processor is transformed into executable code. The executable code includes at least one execution mode flag indicating an operation mode to enable or disable when executing the block with a block-based processor. Suitable operation modes that can be indicated in executable code include at least one or more of the following: execution of the instruction block by two or more processor cores (e.g., for core fusion or vector mode operation), memory-dependence prediction, or deterministic ordering of instruction in the instruction block. In some examples, the execution mode flag includes an indication of the number of cores allocated to the instruction block. In some examples, execution mode flag is included in instruction block header while in other examples, the execution mode flag is imparted for the instruction block by including dedicated block-based processor instructions, by modifying values stored in a designated register or memory location, or other suitable means for indicating the operation mode. In some examples, the designated operation mode is the execution of the instruction block by two or more processor cores causing a processor executing the compiled code to execute the instruction block using two or more processor cores. In some examples, the execution mode flag indicates that the operation mode is to disable memory-dependence prediction based on one or more possible occurrences of memory aliasing, or possible memory aliasing, detected in the instruction block being transformed. In some examples, the execution mode flag indicates that the operation mode is to disable memory-dependence prediction based on determining one or more possible occurrences of memory instructions in the instruction block being transformed, reading, and/or writing to one or more I/O mapped addresses.

At process block 1620, source code and/or object code is transformed into block-based processor executable code including the execution mode flags that were determined at process block 1610. In some examples, determination of the operation modes is determined automatically by the compiler. In other examples, determination of operation modes is determined, at least in part, by directives provided by the programmer of the instruction block code. For example, options within an in-traded development environment, compiler pragmas, defined statements, and/or key words located in comments within source code can be used to, at least in part, indicate operation modes.

The executable code generated by transforming source and/or object code can be stored in a computer-readable storage medium. In other examples, the executable code is provided to a processor as part of an instruction stream (e.g., by sending executable instructions over a computer network, or by interpreting code written in an interpretive language locally.

### XIII. Exemplary Computing Environment

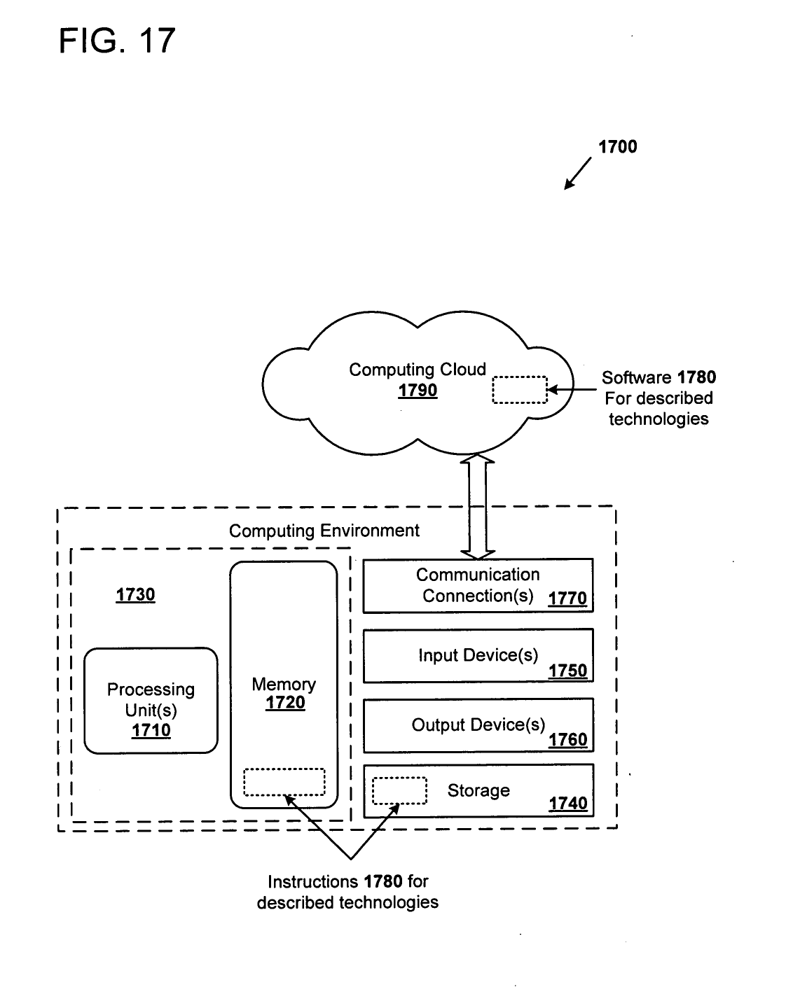

FIG. 17 illustrates a generalized example of a suitable computing environment 1700 in which described embodiments, techniques, and technologies, including configuring a block-based processor, can be implemented. For example, the computing environment 1700 can implement disclosed techniques for configuring a processor to operating according to one or more operation modes, or compile code into computer-executable instructions for performing such operations, as described herein.

The computing environment 1700 is not intended to suggest any limitation as to scope of use or functionality of the technology, as the technology may be implemented in diverse general-purpose or special-purpose computing environments. For example, the disclosed technology may be implemented with other computer system configurations, including hand held devices, multi-processor systems, programmable consumer electronics, network PCs, minicomputers, mainframe computers, and the like. The disclosed technology may also be practiced in distributed computing environments where tasks are performed by remote processing devices that are linked through a communications network. In a distributed computing environment, program modules (including executable instructions for block-based instruction blocks) may be located in both local and remote memory storage devices.

With reference to FIG. 17, the computing environment 1700 includes at least one block-based processing unit 1710 and memory 1720. In FIG. 17, this most basic configuration 1730 is included within a dashed line. The block-based processing unit 1710 executes computer-executable instructions and may be a real or a virtual processor. In a multi-processing system, multiple processing units execute computer-executable instructions to increase processing power and as such, multiple processors can be running simultaneously. The memory 1720 may be volatile memory (e.g., registers, cache, RAM), non-volatile memory (e.g., ROM, EEPROM, flash memory, etc.), or some combination of the two. The memory 1720 stores software 1780, images, and video that can, for example, implement the technologies described herein. A computing environment may have additional features. For example, the computing environment 1700 includes storage 1740, one or more input device(s) 1750, one or more output device(s) 1760, and one or more communication connection(s) 1770. An interconnection mechanism (not shown) such as a bus, a controller, or a network, interconnects the components of the computing environment 1700. Typically, operating system software (not shown) provides an operating environment for other software executing in the computing environment 1700, and coordinates activities of the components of the computing environment 1700.

The storage 1740 may be removable or non-removable, and includes magnetic disks, magnetic tapes or cassettes, CD-ROMs, CD-RWs, DVDs, or any other medium which can be used to store information and that can be accessed within the computing environment 1700. The storage 1740 stores instructions for the software 1780, plugin data, and messages, which can be used to implement technologies described herein.

The input device(s) 1750 may be a touch input device, such as a keyboard, keypad, mouse, touch screen display, pen, or trackball, a voice input device, a scanning device, or another device, that provides input to the computing environment 1700. For audio, the input device(s) 1750 may be a sound card or similar device that accepts audio input in analog or digital form, or a CD-ROM reader that provides audio samples to the computing environment 1700. The output device(s) 1760 may be a display, printer, speaker, CD-writer, or another device that provides output from the computing environment 1700.

The communication connection(s) 1770 enable communication over a communication medium (e.g., a connecting network) to another computing entity. The communication medium conveys information such as computer-executable instructions, compressed graphics information, video, or other data in a modulated data signal. The communication connection(s) 1770 are not limited to wired connections (e.g., megabit or gigabit Ethernet, Infiniband, Fibre Channel over electrical or fiber optic connections) but also include wireless technologies (e.g., RF connections via Bluetooth, WiFi (IEEE 802.11a/b/n), WiMax, cellular, satellite, laser, infrared) and other suitable communication connections for providing a network connection for the disclosed methods. In a virtual host environment, the communication(s) connections can be a virtualized network connection provided by the virtual host.

Some embodiments of the disclosed methods can be performed using computer-executable instructions implementing all or a portion of the disclosed technology in a computing cloud 1790. For example, disclosed compilers and/or block-based-processor servers are located in the computing environment, or the disclosed compilers can be executed on servers located in the computing cloud 1790. In some examples, the disclosed compilers execute on traditional central processing units (e.g., RISC or CISC processors).

Computer-readable media are any available media that can be accessed within a computing environment 1700. By way of example, and not limitation, with the computing environment 1700, computer-readable media include memory 1720 and/or storage 1740. As should be readily understood, the term computer-readable storage media includes the media for data storage such as memory 1720 and storage 1740, and not transmission media such as modulated data signals.

### XIV. Additional Examples of the Disclosed Technology

Additional examples of the disclosed subject matter are discussed herein in accordance with the examples discussed above.

In some examples of the disclosed technology, an apparatus includes one or more block-based processor cores, at least one of the cores being configured to decode an instruction block header for a block-based processor instruction block including one or more fields and configure at least one of the cores to execute instructions in the instruction block according to a mode of operation specified by at least one of the fields, the mode including one or more of the following: core fusion operation, vector mode operation, memory dependence prediction operation, and/or in-order execution operation. In some examples, the specified mode is the core fusion operation, and the field corresponding to the specified mode further indicates a number of cores of the block-based processor to allocate to execution of the instruction block. In some examples, the fields are stored in a special-purpose register or memory location in a separate location from instructions of the instruction block.

In some examples, at least one of the cores is configured to execute instructions according to two or more operation modes. In some examples, the fields are encoded in bits 13 through 6 of the instruction block header. In some examples, the apparatus includes computer-readable storage media storing data for the instruction block header and for the instructions in the instruction block. In some examples, the block-based processor is implemented as a field programmable gate array, an application-specific integrated circuit, and/or an integrated circuit.

In some examples, a method of operating a block-based or EDGE ISA processor includes configuring the processor to execute a block of explicit data graph execution instructions according to data indicating a selected one or more operation modes and executing at least one instruction in the block of instructions according to at least one of the selected operation modes, each of the selected modes determining a respective one of the following aspects of the executing: a number of cores allocated to executing the block of instructions, an order in which instructions of the block of instructions are executed, or operation of a memory dependence prediction unit.

In some examples, the processor receives the data in an instruction stream comprising the block of instructions. In some examples, the instruction stream includes an instruction header. In some examples, the instruction stream is stored as object code generated by a compiler, or streamed as instructions from a just-in-time compiler. In some examples, the data is stored in a designated register in the processor or a designated memory location accessible by the processor and the executing the at least one instruction in the block of instructions is performed using a number of cores indicated by the data.

In some examples, the number indicated is a first number of cores, and the method further includes, after executing and committing the instruction block at least once, changing the data stored in the designated register to indicated a second, different number of cores, and executing the at least one instruction of the instruction block by using the second number of cores indicated by the data. In some examples, the mode indicates a deterministic order in which instructions of the block of instructions are to be executed the executing is performed by the processor according to the deterministic order. In some examples, the mode indicates a sequential order in which instructions of the block of instructions are to be executed and the executing is performed according to the sequential order. In some examples, the mode specifies an order in which instructions of the block of instructions are to be executed and the method further includes, based on the mode, executing instructions in the block of instructions in a single-step manner according to the specified order while a software debugger is being executed by the processor. In some examples, the sequential or deterministic order modes are used when the processor is configured to be in a debugging mode.

In some examples, the mode determines number of cores allocated to executing the block of instructions. In some examples, the mode further indicates that the instruction block is for vector mode execution and the method further includes, based on the mode, allocating two or more cores to execute the instruction block, each of the cores executing the instructions of the instruction block on a portion of a data vector indicated by the instruction block instructions. In some examples, two or more lanes of a single core, each comprising one or more functional units is allocated to perform operations upon a portion of the data vector. In some examples, two or more lanes of a respective two or more cores is allocated to perform operations upon a portion of the data vector.

In some examples, the mode determines a number of cores allocated to executing the block of instructions, and the mode further indicates that the instruction block is for vector mode execution, and the method further includes, based on the mode: allocating a first, master core to execute the block of instructions, the master core being configured to send a signal indicating which instructions of the instruction block are being executed, and allocating a second one or more follower cores to execute the block of instructions, each of the follower cores operating on a portion of a data vector, each of the follower cores executing instructions of the instruction block according to the signal sent by the master core.

In some examples of the disclosed technology, one or more computer-readable storage media store computer-readable instructions that when executed by a processor, cause the processor to perform a method, the instructions comprising instructions for transforming source and/or object code into executable code for a block-based processor, the executable code including at least one execution mode flag indicating an operation mode to enable or disable when executing the block with a block-based processor, and the operation mode being at least one or more of the following: execution of an instruction block by two or more processor cores, memory dependence prediction, and/or deterministic ordering of instructions in the instruction block. In some examples, the operation mode is the execution of the instruction block by two or more processor cores, and the operation mode causes an executing processor to execute the instruction block using two or more processor cores. In some examples, the execution mode flag indicates the operation mode is to disable memory dependence prediction based on one or more occurrences of memory aliasing in the instruction block. In some examples, the execution mode flag indicates the operation mode is to disable memory dependence prediction based on one or more occurrences of memory instructions in the instruction block writing and/or writing to one or more input/output mapped addresses.

In some examples, one or more computer-readable storage media store computer-executable instructions for a block-based processor, that when executed, cause the processor to perform any of the methods disclosed herein.

In view of the many possible embodiments to which the principles of the disclosed subject matter may be applied, it should be recognized that the illustrated embodiments are only preferred examples and should not be taken as limiting the scope of the claims to those preferred examples. Rather, the scope of the claimed subject matter is defined by the following claims. We therefore claim as our invention all that comes within the scope of these claims.

We claim:

1. An apparatus comprising one or more block-based processor cores, at least one of the cores being configured to:
decode an instruction block header for a block-based processor instruction block, the instruction block header including one or more fields; and
configure at least one of the cores to execute instructions in the instruction block according to a mode of operation specified by at least one of the fields, the mode including one or more of the following: core fusion operation, vector mode operation, memory dependence prediction operation, or in-order execution operation.

2. The apparatus of claim 1, wherein the specified mode is the core fusion operation, the field corresponding to the specified mode further indicating a number of cores of the block-based processor to allocate to execution of the instruction block.

3. The apparatus of claim 1, wherein the at least one core is configured to execute instructions according to two or more operation modes.

4. The apparatus of claim 1, wherein the fields are encoded in bits 13 through 6 of the instruction block header.

5. The apparatus of claim 1, wherein the apparatus further comprises computer-readable storage media storing data for the instruction block header and for the instructions in the instruction block.

6. The apparatus of claim 1, wherein the block-based processor cores are implemented as a field programmable gate array, an application-specific integrated circuit, and/or an integrated circuit.

7. A method of operating a processor, the method comprising:
configuring the processor to execute a block of explicit data graph execution instructions according to data indicating a selected one or more operation modes; and
executing at least one instruction in the block of instructions according to at least one of the selected operation modes, each of the selected modes determining a respective one of the following aspects of the executing: a number of cores allocated to executing the block of instructions, an order in which instructions of the block of instructions are executed, or operation of a memory dependence prediction unit.

8. The method of claim 7, wherein the processor receives the data in an instruction header encoded in an instruction stream comprising the block of instructions.

9. The method of claim 7, wherein:
the data is stored in a designated register in the processor or a designated memory location accessible by the processor; and
the executing the at least one instruction in the block of instructions is performed using a number of cores indicated by the data.

10. The method of claim 9, wherein the number is a first number of cores, and wherein the method further comprises, after executing and committing the instruction block at least once:
changing the data stored in the designated register to indicated a second, different number of cores; and
executing the at least one instruction of the instruction block by using the second number of cores indicated by the data.

11. The method of claim 7, wherein:
the mode indicates a deterministic order in which instructions of the block of instructions are to be executed; and
the executing is performed according to the deterministic order.

12. The method of claim 7, wherein:
the mode indicates a sequential order in which instructions of the block of instructions are to be executed; and
the executing is performed according to the sequential order.

13. The method of claim 7, wherein:
the mode specifies an order in which instructions of the block of instructions are to be executed; and
the method further comprises, based on the mode, executing instructions in the block of instructions in a single-step manner according to the specified order while a software debugger is being executed by the processor.

14. The method of claim 7, wherein:
the mode specifies a number of cores to be allocated to executing the block of instructions;
the mode further indicates that the instruction block is for vector mode execution; and
the method further comprises, based on the mode:
allocating two or more cores to execute the instruction block, each of the cores executing the instructions of the instruction block on a portion of a data vector indicated by the instruction block instructions.

15. The method of claim 7, wherein:
the mode specifies a number of cores allocated to executing the block of instructions;
the mode further indicates that the instruction block is for vector mode execution; and
the method further comprises, based on the mode:
allocating a first, master core to execute the block of instructions, the master core being configured to send a signal indicating which instructions of the instruction block are being executed, and
allocating a second one or more follower cores to execute the block of instructions, each of the follower cores operating on a portion of a data vector, each of the follower cores executing instructions of the instruction block according to the signal sent by the master core.

16. One or more computer-readable storage media storing computer-executable instructions for a block-based processor, that when executed, cause the processor to perform the method of claim 7.

17. One or more computer-readable storage media storing computer-readable instructions that when executed by a processor, cause the processor to perform a method, the instructions comprising:
instructions for transforming source and/or object code into executable code for a block-based processor, the executable code including at least one execution mode flag indicating an operation mode to enable or disable when executing the block with a block-based processor, the operation mode being at least one or more of the following: execution of an instruction block by two or more processor cores, memory dependence prediction, or deterministic ordering of instructions in the instruction block.

18. The computer-readable storage media of claim 17, wherein:
the operation mode is the execution of the instruction block by two or more processor cores; and
the operation mode causes an executing processor to execute the instruction block using two or more processor cores.

19. The computer-readable storage media of claim 17, wherein:
the execution mode flag indicates the operation mode is to disable memory dependence prediction based on one or more possible occurrences of memory aliasing in the instruction block.

20. The method of claim 17, wherein:
the execution mode flag indicates the operation mode is to disable memory dependence prediction based on one or more occurrences of memory instructions in the instruction block writing and/or writing to one or more input/output mapped addresses.
